(19) United States
(12) Patent Application Publication
(10) Pub. No.: US 2005/0041289 A1
(43) Pub. Date: Feb. 24, 2005

(54) Advanced prism assemblies and prism assemblies using cholesteric reflectors

(76) Inventor: Arthur Berman, San Jose, CA (US)

Correspondence Address: John W. Carpenter;REED SMITH LLP, Suite 2000, Two Embarcadero Center, San Francisco, CA, 94111, US

(21) Appl. No.: 10/816,996

(22) Filed: Apr. 2, 2004

Related U.S. Application Data
(63) Continuation-in-part of application No. 10/646,291, filed on Aug. 22, 2003.

(51) Int. Cl. G02B 5/30

(52) U.S. Cl. 359/495; 359/831

(57) ABSTRACT

A prism assembly using only cholesteric layers for splitting input light into component light beams and individually directing the component light beams to modulating devices. Liquid coupling prism assembly components to produce reduced stress index and pathlength matched prism assemblies from low tolerance components. Pathlength matching in beam splitting devices using a variety of optical component shapes and beam splitting layer materials. Various prism assembly designs using cholesteric layers supported on planar and/or on optical component diagonals.

### CLAIM OF PRIORITY

This application is a continuation in part of Ser. No. 10/646,291, attorney docket number, 356508.01501. This application claims benefit to Ser. No. 10/251,225, attorney docket number, 356508.00601 for all subject matter common to each application.

### BACKGROUND OF THE INVENTION

1. Field of Invention

The present invention relates generally to optical systems, and more specifically to optical systems used in video and other projection systems.

2. Discussion of Background

The functionality of a video projector (illustrated containing a commercially available prism assembly) is explained with reference to FIG. 1. As shown, white light is generated by a light source. The light is collected, homogenized and formed into the proper shape by the condenser. UV and IR components are eliminated by filters. The white light then enters the prism assembly where it is polarized and broken into red, green and blue beams. (Hence a “three channel” type prism assembly.) These beams then follow different paths within the prism assembly such that each beam is directed to a specific reflective microdisplay. The microdisplay that interacts with the green beam contains the green content of the full color video image. It is similar for the blue and red microdisplays. On a pixel by pixel basis, the microdisplays modulate and then reflect the colored light beams. The prism assembly then recombines the modulated beams into a white light beam that contains a full color video image. The resultant white light beam then exits the prism assembly and enters the projection lens. Finally, the image-containing beam is projected onto a screen.

Some desirable properties of a prism assembly are that it produce an image in which the brightness and color are spatially uniform and meet other required optical properties including those for brightness, color gamut and contrast ratio. Another desirable property is that the prism assembly be manufacturable. That is, that the prism assembly be producible in high volume with good yield and at a high quality level. Finally, and of equal importance, is that the prism assembly meet cost targets. Targets that, for consumer products, are inevitably very challenging.

However, current, commercially available prism assemblies do not fully meet all of the criteria discussed above.

### SUMMARY OF THE INVENTION

The present inventor has discovered a number of advantages in prism systems that utilize cholesteric layers in one of more optical components of the prism systems. The invention relates particularly to video projection systems utilizing reflective microdisplays. More particularly, in one embodiment, the invention is a configuration of a prism assembly that is based on cholesteric based optical components and is suitable for use within a “three channel” LCoS video projector. Other aspects of the invention include production of a pathlength matched prism assembly that is liquid coupled and that utilizes pathlength for matched beam splitters. A video projector so produced is used, for example, in a projection based HDTV.

### BRIEF DESCRIPTION OF THE DRAWINGS

FIG. 1 is drawing of a reflective microdisplay based video projector;

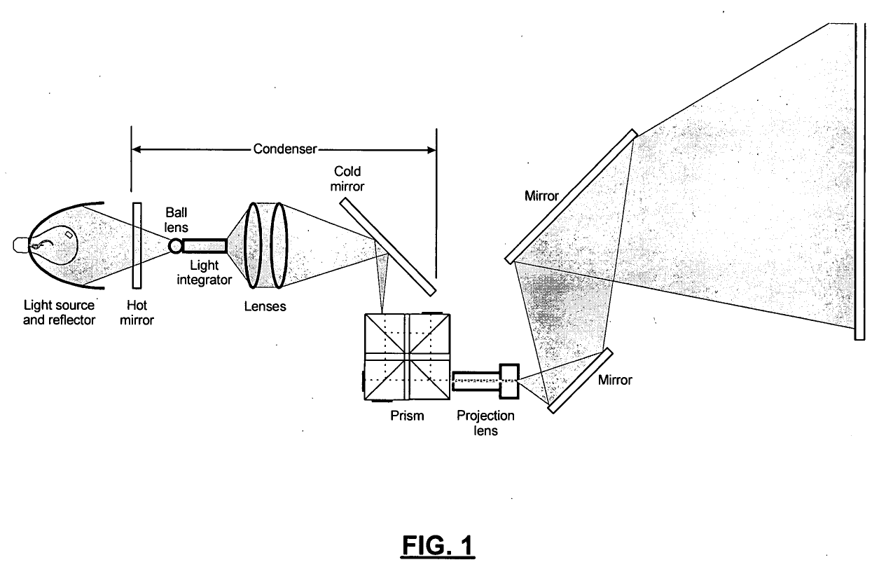

FIG. 2A is an illustration of interactions of unpolarized white light with a “right hand green” cholesteric film;

FIG. 2B is an illustration of interactions of unpolarized white light with a “right hand red” cholesteric film;

FIG. 2C is an illustration of interactions of unpolarized white light with a “right hand blue” cholesteric film;

FIG. 3 is an example cholesteric based kernel according to an embodiment of the present invention;

FIG. 4 is an illustration of lightpaths through the cholesteric based kernel shown in FIG. 3;

FIG. 5 is a second example embodiment of a cholesteric based kernel according to an embodiment of the present invention;

FIG. 6 is an illustration of lightpaths through the cholesteric based kernel shown in FIG. 5.

FIG. 7 is a drawing of an example kernel in which various aspects of the present invention are applied;

FIG. 8 is drawing illustrating a prism assembly construction technique prism assembly according to an embodiment of the present invention;

FIG. 9 is a drawing of liquid coupling of prism assembly components according to an embodiment of the present invention;

FIGS. 10A and 10B are drawings of top and side views of a frame that holds components of a prism assembly according to an embodiment of the present invention;

FIG. 11 is a drawing of an example mechanism utilized to hold prism assembly components according to an embodiment of the present invention;

FIG. 12 is a drawing of a prism assembly equipped with a flexible diaphragm according to an embodiment of the present invention;

FIG. 13 is a drawing of an embodiment of a bladder equipped prism assembly according to an embodiment of the present invention;

FIG. 14 is a drawing of an embodiment of a sealed tube equipped prism assembly according to an embodiment of the present invention;

FIG. 15 is a drawing of an internally sealed prism assembly according to an embodiment of the present invention; and

FIG. 16 is a close-up of an internal seal of an internally sealed prism assembly according to an embodiment of the present invention.

FIG. 17 is an illustration of a pathlength matched Polarizing Beam Splitter (PBS) cube;

FIG. 18A is an illustration of a device used to produce a pathlength matched PBS cube according to an embodiment of the present invention;

FIG. 18B is a flow chart of a process for producing a pathlength matched beam splitter;

FIG. 18C is an illustration of a device and method according to an embodiment of the present invention;

FIG. 19 is a drawing of a kernel 1900 according to an embodiment of the present invention;

FIG. 20 is a drawing of prism assembly and kernel design according to an embodiment of the present invention; and

FIG. 21 is a drawing of prism assembly and kernel design according to an embodiment of the present invention.

### DESCRIPTION OF THE PREFERRED EMBODIMENTS

Technical details about the structure, construction, and operation of cholesteric layers is now discussed. The cholesteric layers are generally thin layers of cholesteric liquid crystal.

The cholesteric layers react with light in a unique way that the present invention takes advantage of to produce efficient prism assemblies. The molecular structure of a cholesteric is such that it interacts with light by either passing or reflecting light of a given wavelength band and polarization. Cholesterics can be produced to either pass or reflect light at the given wavelength and polarization for various polarizations and wavelengths of light (e.g., a “red” cholesteric that reflects light in the red light bandwidth, or a “green” cholesteric that reflects light in the green light bandwidth, for example).

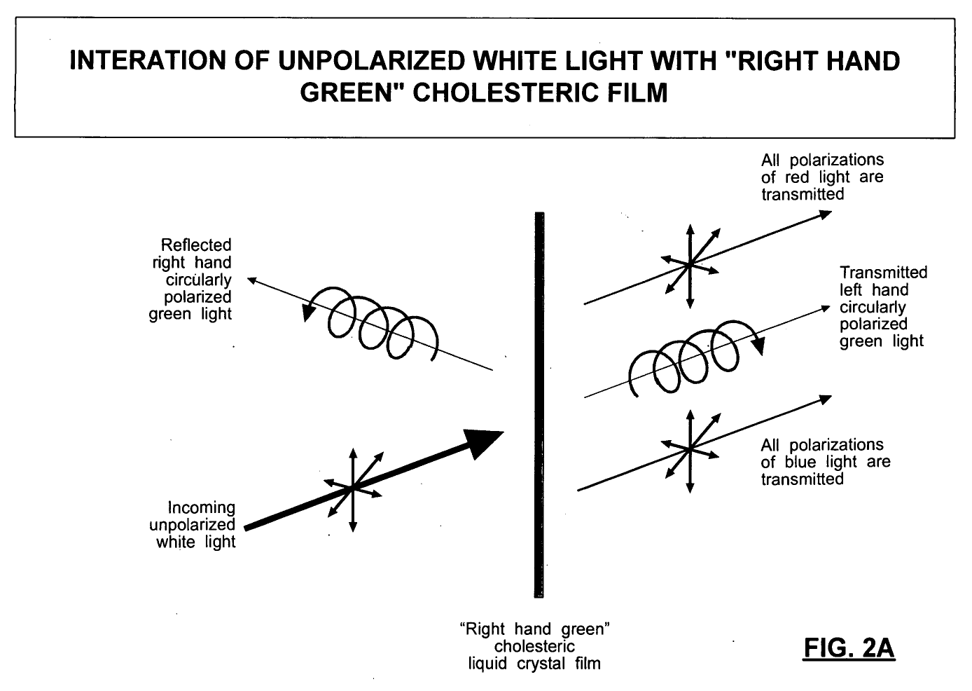

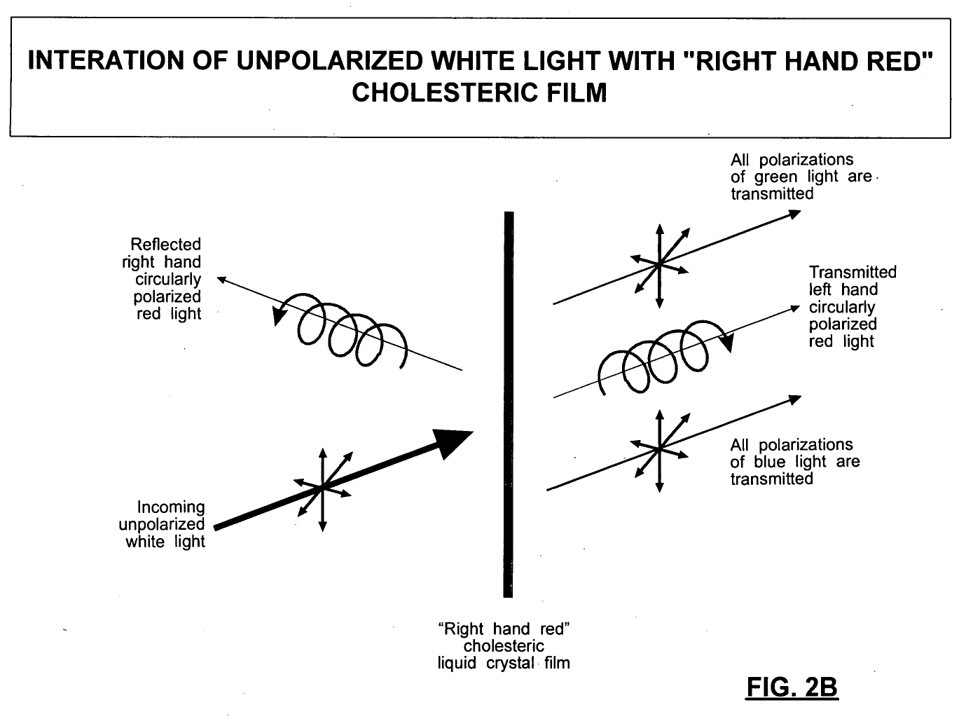

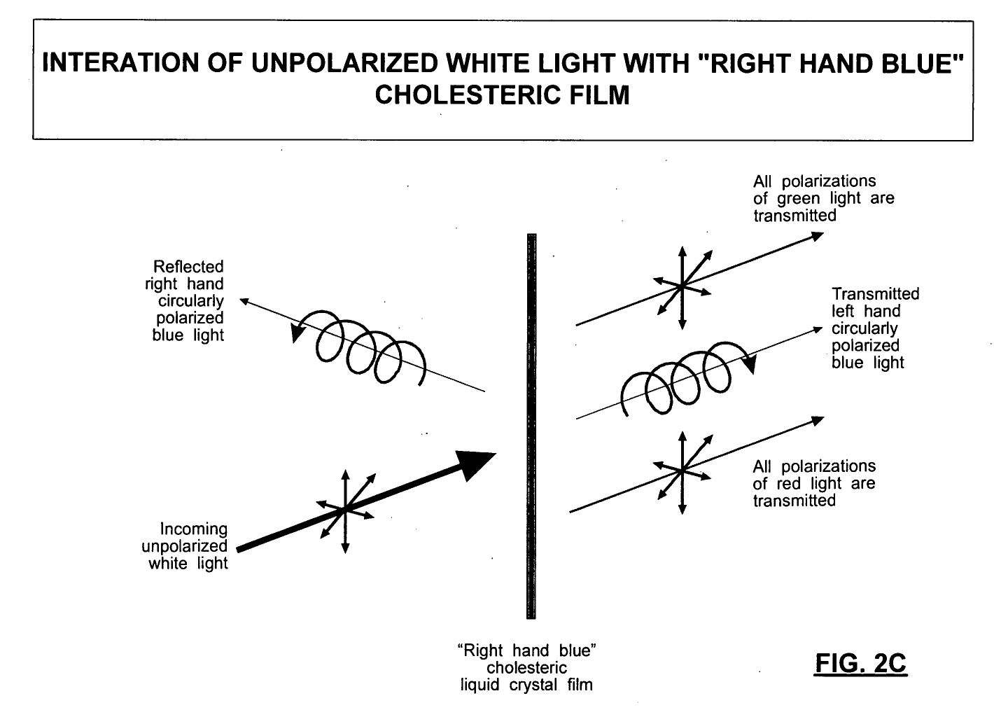

Referring again to the drawings, wherein like reference numerals designate corresponding parts, and more particularly to FIGS. 2A-2C thereof, there is illustrated the interaction of unpolarized white light with various thin layers of cholesteric liquid crystal. The variation of cholesteric layer illustrated in FIG. 2A can be called “right hand green”. In this case, the molecular structure of the cholesteric is such that the layer transmits green left hand circularly polarized light. Green right hand circularly polarized light is specularly reflected. Blue and red light of both polarizations are transmitted. The width of the reflective band (bandwidth) of the cholesteric material is determined as follows:
Δλ=(Δnλmax)/navg
where Δn is the birefringence and navg the average index of refraction of the cholesteric.
λmax is the wavelength of maximum reflectivity (essentially, the center of the reflective band). The efficiency of the reflection can be very high when the light is normally incident to the plane of the film. The efficiency decreases when the angle of incidence is off normal. In addition, the reflective maximum shifts to shorter wavelengths as the angle deviates from normal.

FIG. 2B illustrates the interaction of unpolarized white light with a layer of right hand, blue cholesteric. As shown, all red and green light is transmitted. Right hand blue light is specularly reflected and left hand blue light is transmitted.

FIG. 2C illustrates the interaction of unpolarized white light with a layer of right hand, red cholesteric. As shown, all blue and green light is transmitted. Right hand red light is specularly reflected and left hand red light is transmitted.

Cholesteric layers can also be fabricated that are left-handed. In this case, left hand circularly polarized light within the appropriate bandwidth is reflected and right hand circularly polarized light along with left-hand out of band light is transmitted.

The cholesteric layer can be in any one of several physical forms. In the first form, the cholesteric is a fluid and may, for example, be contained between two substrates (the substrates can be cover glasses or the components in the prism assembly). The layer can also be made in the form of a polymer. A cholesteric encapsulated in the layer may also be utilized.

Some current methods for producing the cholesteric layer include, for example:
A liquid precursor material is introduced into a cell (such as by vacuum filling) and then polymerized in place by exposure to UV light;
A liquid precursor material is doctor bladed onto a substrate and subsequently polymerized by exposure to UV light; and
A liquid precursor material is spin coated onto a substrate and then polymerized by exposure to UV light. It is also noted that when referring to a cholesteric layer herein, the cholesteric layer itself may be composed of more than one layer or thin film.

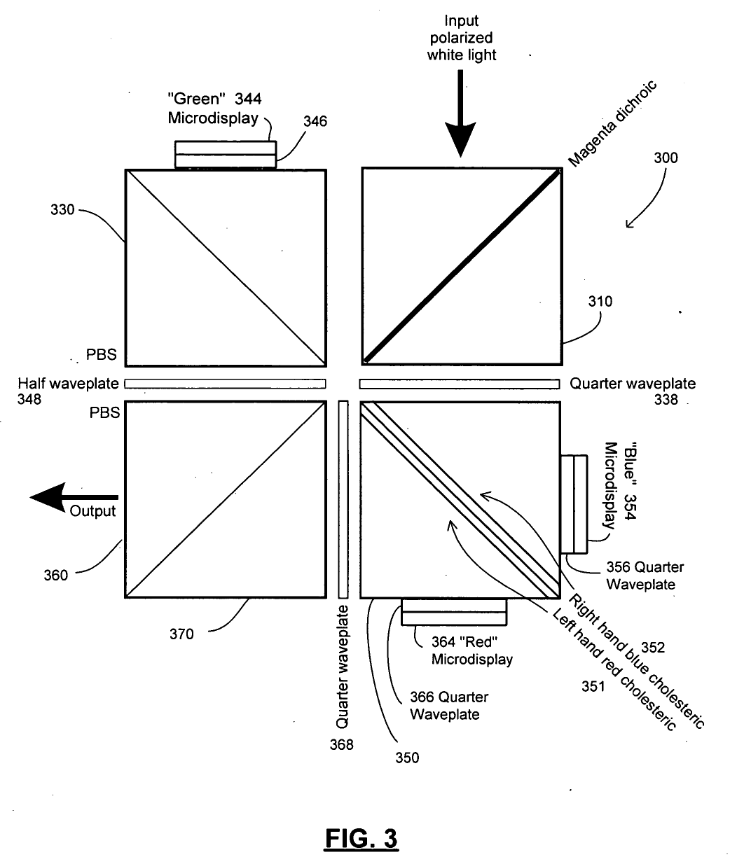

FIG. 3 is an illustration of a prism assembly 300 configuration in which each component is named (the prism assembly plus the microdisplays may also be referred to as a kernel). The prism assembly 300 includes a dichroic beam splitter (dichroic cube) 310, 2 polarizing beam splitters (PBSs) 330, 370, and a Cholesteric Beam Splitter (CBS) 350 (a beam splitter based on a cholesteric beam splitting element). Each of the dichroic cube, PBSs, and the CBS perform a part of separating and/or combining, of the individual light paths in the prism assembly 300. Light entering the prism assembly 300 is separated into green, blue and red light beams each following a corresponding green, blue, or red light path through the prism assembly and kernel. The light beams are individually directed to corresponding “green,” “red,” and “blue” microdisplays (red light beam directed to the “red” microdisplay, the blue light beam directed to the “blue” microdisplay, and so forth). The individual light beams are modulated and reflected off their corresponding microdisplay and then re-combined to produce an output.

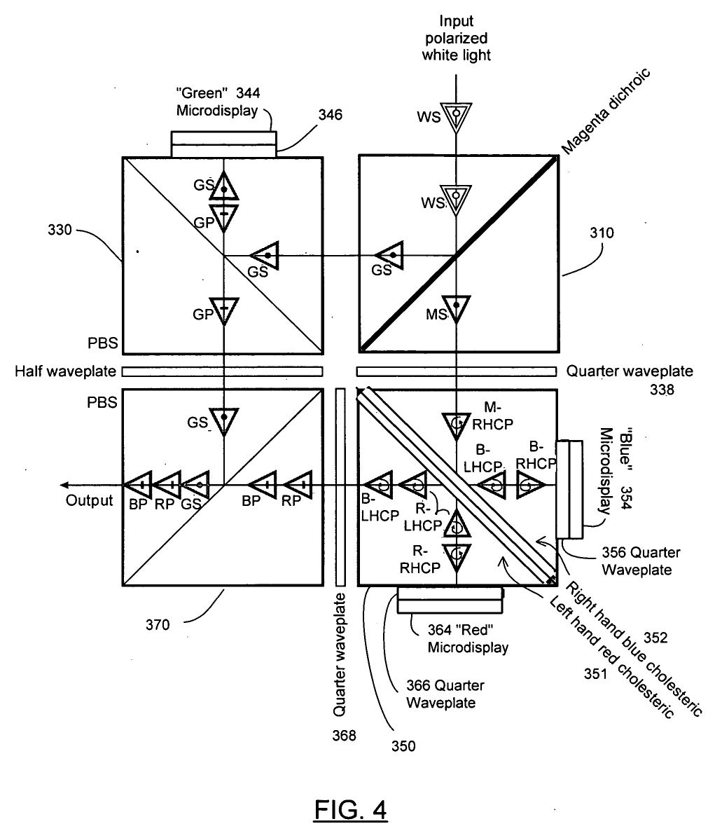

FIG. 4 illustrates the path and polarization of the light at each point within the prism assembly 300 configuration. Dichroic cube 310 divides the input polarized white light into a GS (green s-polarized) light beam and a second light beam that is converted to a MS (magenta s-polarized) light beam after passing through the magenta dichroic. Quarter waveplate 338 converts the MS light beam to magenta—right hand circularly polarized M-RHCP) light.

A blue component (B-RHCP) of the M-RHCP is reflected off the right hand blue cholesteric 352 (of the cholesteric based beam splitter 350) toward the “blue” microdisplay 354. Although other microdisplay devices may be configured for use with the various techniques and prism assembly/kernel configurations disclosed herein, the main embodiments of the present invention are directed to prism assemblies intended to use reflective Liquid Crystal on Silicon (LCOS) microdisplays. Reflection off the microdisplay imposes pixel by pixel polarization based modulation in the reflected beam. Thus, the blue component is directed toward the “blue” microdisplay while the “blue” microdisplay is energized or otherwise “displays” the blue content of an image (e.g., video image), modulating the blue component. The blue image content, now modulated in and carried by the reflected blue component, is left hand circularly polarized (B-LHCP) and passes through both the right hand blue cholesteric 352 and the left-hand red cholesteric 351 toward the output. Portions of the blue component that are not modulated (e.g., a portion of the image that has no blue content), or portions not fully modulated (e.g., a portion of the image that is not fully blue), remain B-RHCP and are reflected off the blue cholesteric 352 and exit the prism assembly as waste light.

Quarter waveplates 346, 356, and 366 are respectively positioned in the light paths of the green, blue, and red light channels, prior to the corresponding “green,” “blue,” and “red” microdisplays. The primary function of quarter waveplates 346, 356, and 366 is to compensate for residual retardation found in the microdisplays. In some cases, depending upon various design aspects of a particular prism assembly/kernel, the quarter waveplates 346, 356, and 366 may also perform skew ray compensation. The quarter waveplates 346, 356, and 366 may, for example, be set up for both residual retardation compensation and skew ray compensation when the principle axis of a waveplate needed to compensate for both residual retardation and skew ray compensation are the same, or close to the same (e.g., the principle axis of the quarter waveplate is split between the optimal residual retardation orientation and the optimal skew ray compensation orientation). However, in other embodiments, 2 different quarter waveplates are inserted into each light channel, a first quarter waveplate oriented to provide optimal residual retardation compensation and a second quarter waveplate oriented to provide optimal skew ray compensation (in these embodiments, for example, quarter waveplate 346 represents both the first and second quarter waveplates).

In some embodiments, for light channels that utilize circularly polarized light (e.g., light channels having one or more cholesteric based beam splitters), yet another quarter waveplate may be inserted in optical series in the light channel and be oriented to convert the circularly polarized light into linearly polarized light prior to modulation by the microdisplay(s). This conversion occurs when the principle optical axis of the quarter waveplate is oriented at 45 degrees relative to the principle axis of the circularly polarized light incident upon the waveplate.

For example, in one embodiment, quarter waveplate 356 represents a first quarter waveplate that is oriented to perform residual retardation compensation and a second quarter waveplate (¼ lambda waveplate) that is oriented to perform conversion of the circularly polarized B-RHCP light to linear polarization. Upon reflection by the blue microdisplay 354, the second quarter waveplate reconverts the reflected image carrying blue component back to circular polarization (the modulated portion now left hand circularly polarized), modulated B-LHCP, which then passes through both the right hand blue cholesteric 352 and the left-hand red cholesteric 351 toward the output.

However, microdisplay designs do not necessarily require linear polarized light to perform adequate modulation. Thus, the light channels may operate with a number of configurations of quarter waveplates operating to compensate residual retardation, skew rays, and conversion of linear and circularly polarized lights. Several of the noted configurations, among other possible designs, are noted in Table A.

TABLE A

| | Residual | | Combined | Circular & |
|---|---|---|---|---|
| Light | Retardation | Skew Ray | Residual & | Linear |
| Channel | Compensa- | Compensa- | Skew Ray | Polarization |
| Polarization | tion | tion | Compensation | Conversions |
| Linear | ✓ | | | |
| Linear | ✓ | ✓ | | |
| Linear | | | ✓ | |
| Circular | ✓ | | | |
| Circular | ✓ | ✓ | | |
| Circular | | | ✓ | |
| Circular | ✓ | | | ✓ |
| Circular | ✓ | ✓ | | ✓ |
| Circular | | | ✓ | ✓ |

Returning now to the discussion of the M-RHCP light, a red component thereof, R-RHCP, is transmitted through both cholesterics 352 and 351 and interacts with and is modulated by the red microdisplay 364. Upon reflection by the red microdisplay, the modulated red component, now left hand circularly polarized, reflects off the left hand red cholesteric 351 directing it toward the output.

An additional quarter waveplate 368 is inserted to convert the modulated red and blue light beams back to linear polarization for output. Both the modulated red and modulated blue light beams are recombined with the modulated green light beam in PBS 370.

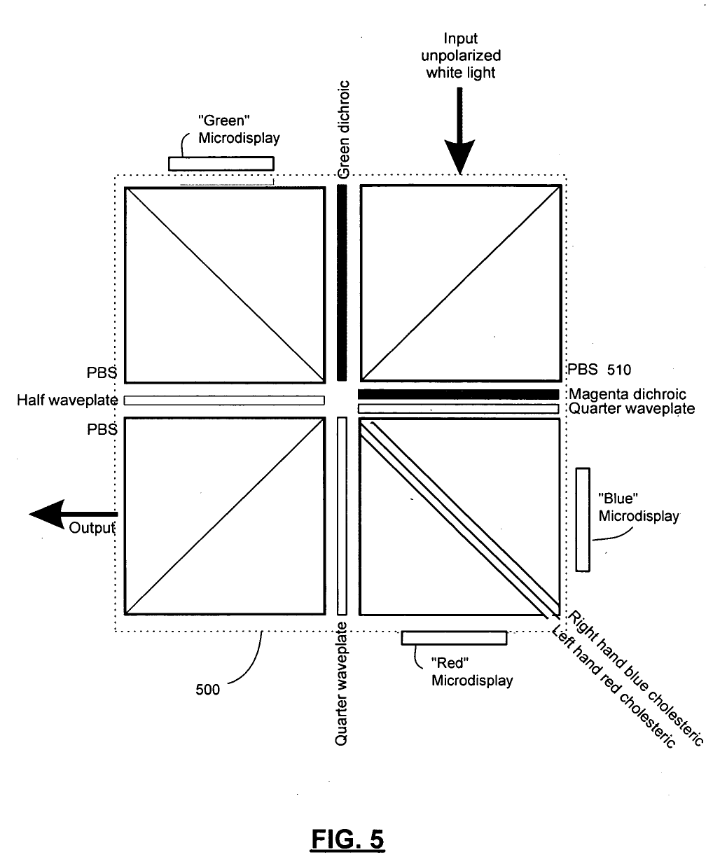

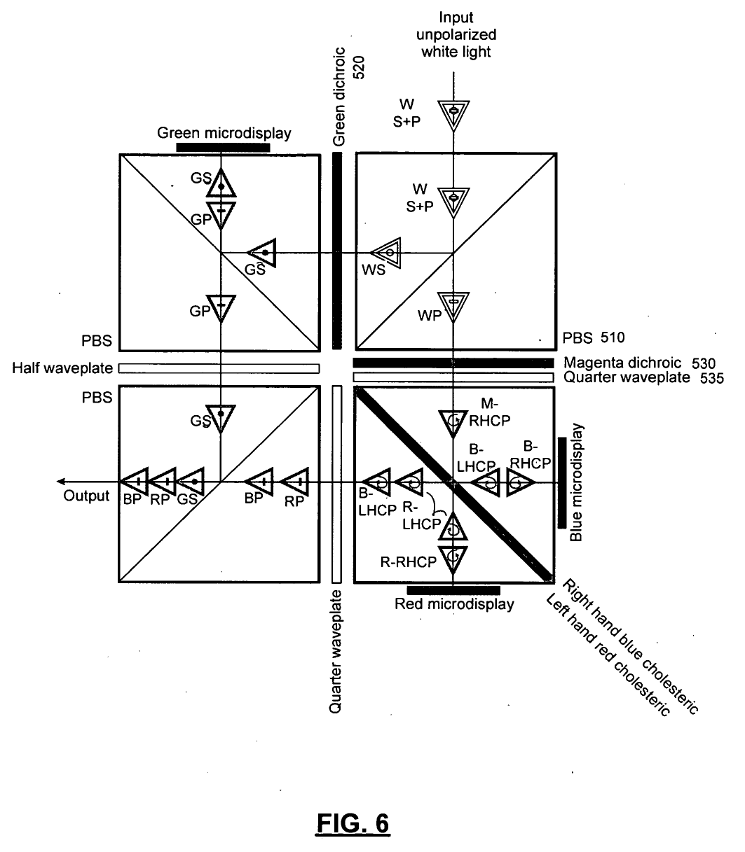

FIG. 5 is an illustration of another example prism assembly configuration. FIG. 6 illustrates the path and polarization of light at each point within the prism assembly configuration of FIG. 5. Prism assembly 500 is configured for input of unpolarized white light. PBS 510 splits the input light into a first S-polarized beam and a second P-polarized beam. A green dichroic 520 converts the S-polarized beam into a green light beam and a magenta dichroic 530 along with a quarter waveplate 535 converts the second P-polarized beam into M-RHCP light.

Note that the illustrations indicate only the key optics in the configurations. The actual prism assembly may require additional components. More specifically, a “clean-up” polarizer can be inserted to the S polarization path of the PBS to improve the contrast ratio. Preferably, this would be a reflective polarizer. In addition, “spacer glasses” can be inserted between any of the PBS “cubes” to equalize the optical path lengths from the reflective surfaces of the microdisplays to the output face of the prism assembly.

Also note that the “joints” between the components in the optical path can be conventional, that is, a rigid adhesive. Alternately, the joints can be liquid filled. A further advantage of utilizing liquid filled joints is the possibility of reducing component count by adjusting the thickness of the liquid joints and eliminating the spacer glasses. In a further alternative, the gaps can be “filled” with air (possibly requiring anti-reflection coatings on exposed surfaces).

An additional configuration alternative available to the disclosed prism assemblies using PBSs is to replace one or more of the PBSs with a reflective polarizer oriented at 45 degrees (at this time, such reflective polarizers are produced by Moxtek, Inc.). Furthermore, the magenta dichroic in the configuration of FIG. 4 can be a planar component oriented at 45° in air rather than the illustrated cube structure. In the embodiments utilizing dichroics, the part count may be reduced by placing the dichroic films on adjacent prism component rather than placing them on separate components.

In the above disclosed configurations, the light output from the prism assembly is linearly polarized but the green polarization direction is orthogonal to that of the red and the blue. In some video projector applications, such as those in which the screen contains a linear polarizer, it is desirable that all the light output by the prism be linearly polarized in one direction. This can be accomplished by placing a wavelength specific retarder in optical series with the output beam. (Such material is produced by ColorLink Corp and called a ColorSelect, which may be described as a half waveplate in the green portion of the spectrum and a 0 or 1 lambda retarder in the red and blue portion of the spectrum).

Note that configurations can be adjusted so that the prism assemblies can accept not only unpolarized input light but also light that is either linearly or circularly polarized. This is accomplished by the placing an appropriate waveplate at the input to the kernel.

A comment related to the cholesteric layer. Since the nominal light ray is incident on the cholesteric layer at 45 degrees, the center wavelength of the cholesteric (λmax) should be chosen such that the shift towards the blue places the reflective/polarizing band of the cholesteric at the desired portion of the spectrum.

Wavelength specific quarter waveplates may be included in one or more embodiments and may be placed in optical series with each microdisplay and oriented so as to convert the circularly polarized input beams to linear polarization. The same quarter waveplate will convert the reflected beams back to circular polarization.

Note that the illustration indicates only the key optics in the configuration. The actual prism assembly may require additional components. As an example, the cholesteric films can be supported by glass plates or placed between the diagonals of triangular prisms. All light output from the prism assembly is circularly polarized but, if desired, can be converted to linear polarization by the inclusion of a quarter waveplate at the output (e.g., exit face 360).

In one embodiment, the components of the prism assembly are set in prism assembly pathlength matched positions. With reference to a prism assembly, pathlength matching, or pathlength matched positions, may be described, for example, as light pathlengths between faces of the prism assembly components on which microdisplays are mounted and a reference plane (e.g., exit face 360, or a plane in a light management system in which the prism assembly is installed) are approximately equivalent. Preferably, approximately equivalent means that the pathlengths are equivalent within a tolerance with which picture quality of an image carried by the combined lights of the output is not degraded due to pathlength inequality. Thus, individual light beams of each of the separate light beams corresponding to a same image pixel once reflected off the microdisplays arrive at the reference plane after traveling the same distance. And, since the pathlengths within the prism are matched, the prism assembly is referred to as a pathlength matched prism assembly. Distances traveled within the prism by each of the light beams after being reflected from the microdisplays are the same.

Prism components themselves are not precise enough, particularly in mass quantity production, to lend themselves to a production process that simply bonds the prism assembly components directly together and end up with matched pathlengths in the prism. One method for producing a pathlength matched prism assembly from standard mass produced optical components, comprises arranging the beam splitters in pathlength matched positions and fixing them to a plate or frame, inserting any other components (e.g. planar optical components) in gaps between the beam splitters, and filing any remaining gaps or spaces with an optical coupling fluid such as mineral oil or other commercially available index matching fluid. The method applies to both PBS and CBS based kernels and prism assemblies, regardless of the kernel/prism assembly configuration or the structure of their components.

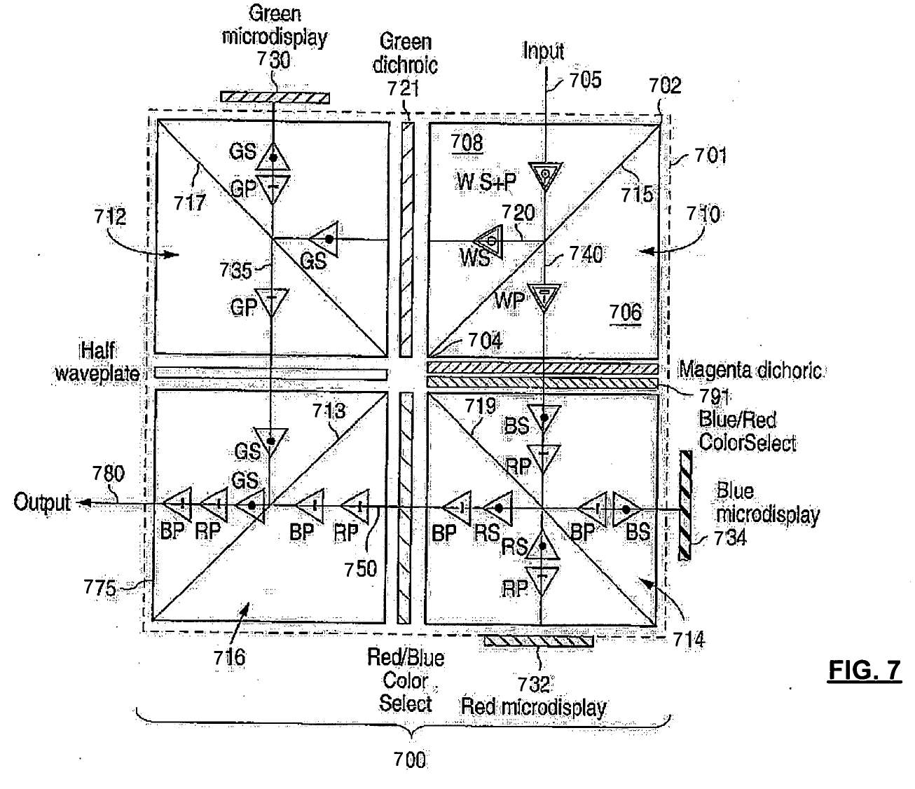

Referring now to FIG. 7 thereof, there is illustrated a kernel 700 illustrating lightpaths and components of one possible configuration of a prism assembly. The kernel 700 includes a prism assembly 701, attached microdisplays (“Green” microdisplay 730, “Red” microdisplay 732, and “Blue” microdisplay 734—the colors are in quotations because the color corresponds to the content of an image to be displayed, or the light being manipulated, by the individual microdisplay).

The prism assembly 701 comprises a set of optical components (e.g. beam splitters, films/optical elements, and matching elements) making a single prism assembly unit. A white light 705 is directed at a Polarizing Beam Splitter (PBS) 710. A polarizing beam splitter thin film 715 perpendicularly polarizes and splits the white light into two beams of polarized light 720 and 740. The lightpaths through the prism assembly are each labeled to indicate the color and polarization of each light path. For example, incoming white light 705 is labeled W S+P (meaning White S and P polarized); light beam 720 is initially labeled WS (meaning white, s-polarized). The s-polarized white light 720 passes through a green dichroic filter 721 (passing green light, making beam 720 a green s-polarized beam (and labeled GS)), and enters a second beam splitter 712. A polarizing beam splitter thin film 717 reflects the s-polarized green light to “green” microdisplay 730.

The green microdisplay 730 manipulates the polarized green light according to green content of an image to be displayed. The “green” microdisplay modulates the polarization of the green light on a pixel-by-pixel basis. For example, a no green content pixel of the image to be displayed will be left unaltered, a strong green content pixel of the image to be displayed will have its polarization rotated 90°, and other pixels having varying levels of green content will have their polarization rotated in varying amounts in proportion to the amount of green content. The microdisplay also reflects the green light (now modulated) back toward the polarizing beam splitter thin film 717. Other microdisplay designs with varying modulation schemes may also be utilized, and, depending on the design, may require corresponding changes in the prism assembly.

The polarizing beam splitter thin film 717 then reflects some portions and passes other portions of the green light. The amount of light reflected versus passing is based on the amount of modulation performed on the reflected green light. Light with the same polarization as was reflected into the green microdisplay is again reflected. Light that is oppositely polarized (or at least different from a polarization sensitivity of the polarizing beam splitter thin film 717) is passed. Amounts of green light less than the full amount of original green light and more than 0 depend on the amount of modulation.

Beam 735 represents the modulated green light that passes (transmits) through the polarizing beam splitter thin film 717 (e.g. green light sufficiently modulated to pass through the polarizing beam splitter thin film 717). Beam 735 enters final beam splitter 716 and is reflected off polarizing beam splitter thin film 713.

White P polarized beam 740 travels through a Magenta Dichroic that converts the white P polarized light beam into a combined P polarized red light beam and a P polarized blue light beam. A Blue/Red ColorSelect material 791 changes the polarization of the blue light beam to S polarization.

The S polarized blue light beam is reflected off polarizing beam splitter thin film 719 (e.g., a thin film, coating, or other polarizing layer) toward the “blue” microdisplay 734. The microdisplay modulates and reflects the blue light beam. The modulated portion of the blue light beam (now P polarized) passes through the polarizing beam splitter thin film 719 toward the output.

The P polarized red light beam passes through the polarizing beam splitter thin film 719 and is modulated and reflected by the “red” microdisplay 732. The modulated portion of the red light beam (now S polarized) is reflected off the polarizing beam splitter thin film 719 toward the output.

In travelling toward the output, both the modulated blue light beam and the modulated red light beam pass through a red/blue ColorSelect which converts the modulated red light beam to P polarization. Both the modulated blue and modulated red light beams (beams 750) then pass through polarizing layer 713.

After reflecting off polarizing beam splitter thin film 713, the modulated green light beam 735 is combined with the red and blue components of beams 750 and then exits the prism assembly through output face 775 as white light 780 containing the image to be displayed.

PBSs 710, 712, 714, and 716 are constructed similarly. In this configuration, each PBS comprises 2 optical components (e.g., prisms 708 and 706) and a polarizing beam splitter layer (e.g., thin film 715). The polarizing beam splitter thin film is, for example, a coating that reflects s-polarized light and passes p-polarized light. Optical elements (e.g., retarders, rotators, etc) are utilized to change the polarization so that desired light beams are either reflected or passed by the polarizing beam splitter thin film so that subsequent polarizing beam splitter thin films may pass or reflect the desired light beams depending on the configuration of optical components and the desired path of each light beam (FIG. 7 is one example configuration and desired paths). For example, when PBS 710 splits the incoming white light into 2 beams, the second beam 740 passes through a wavelength specific retarder (Blue/Red ColorSelect 791) so that PBS 714 can also split beam 740 into component beams directed to each of the red microdisplay 732 and blue microdisplay 734 (without the retarder, the blue component of the white light in beam 740 would remain p-polarized and PBS 714 would then pass the blue light to the red microdisplay 732 instead of reflecting it to the blue microdisplay 734).

The configuration of FIG. 7 illustrates a prism assembly made from 4 similarly constructed PBSs, an advantage over systems utilizing optical components performing a variety of functions (and hence, a variety of differently configured optical components) because the similarly constructed PBSs reduce the number of parts and different functionality of components in a particular optical design. Hence, a corresponding production line benefits from economies of scale, reduced inventory, etc. However, based on the present disclosure, it can also be seen that many different combinations of optical elements can be utilized to make the various beams properly reflect or pass and then re-combine into final light beam 780. Furthermore, the prism assemblies using optical components having a variety of different functions can be constructed. And, as noted above, prism assemblies of all these varieties (different sizes, different shapes, different configurations, etc.) may be constructed using the techniques and processes discussed herein.

The beam splitter is one of the optical components of several prism assemblies disclosed herein. The beam splitters themselves are also composed of optical components. For example, individual prisms 706 and 708 are optical components that are combined to produce the Polarizing Beam Splitter (PBS) 710. Prism assembly 701 illustrates four beam splitters, polarizing beam splitters (PBSs), 710, 712, 714, and 716. Each of the PBSs contain a polarizing beam splitting element (e.g., polarizing beam splitting thin films 715, 717, 719, and 713). Preferably, the polarizing beam splitting thin films are at the diagonal of the beam splitters and extend through the corner as defined by the outside surfaces of the PBS. For example, the polarizing beam splitter thin film 715 extends along the diagonal of 706 and 708 through corners 702 and 704 of the PBS 710. The PBSs may be constructed so that the polarizing beam splitter thin film is on a plane of the diagonal and need not extend through the corners, particularly if light does not pass through the entire range of the diagonal.

The assembly of such PBS is accomplished by the use of optical pathlength matching. Referring to PBS 710, it can be noted that the two prism components 706 and 708 need not be exactly the same size (and, consequently, the outside dimensions of the PBS need not meet any specific dimensional requirement). Since there are no specific dimensional requirements for the PBS, optical components with a “loose” mechanical tolerance may be utilized. Such optical components (and prisms used to construct those components) can be produced at modest cost and in high volume by existing vendors of optical components.

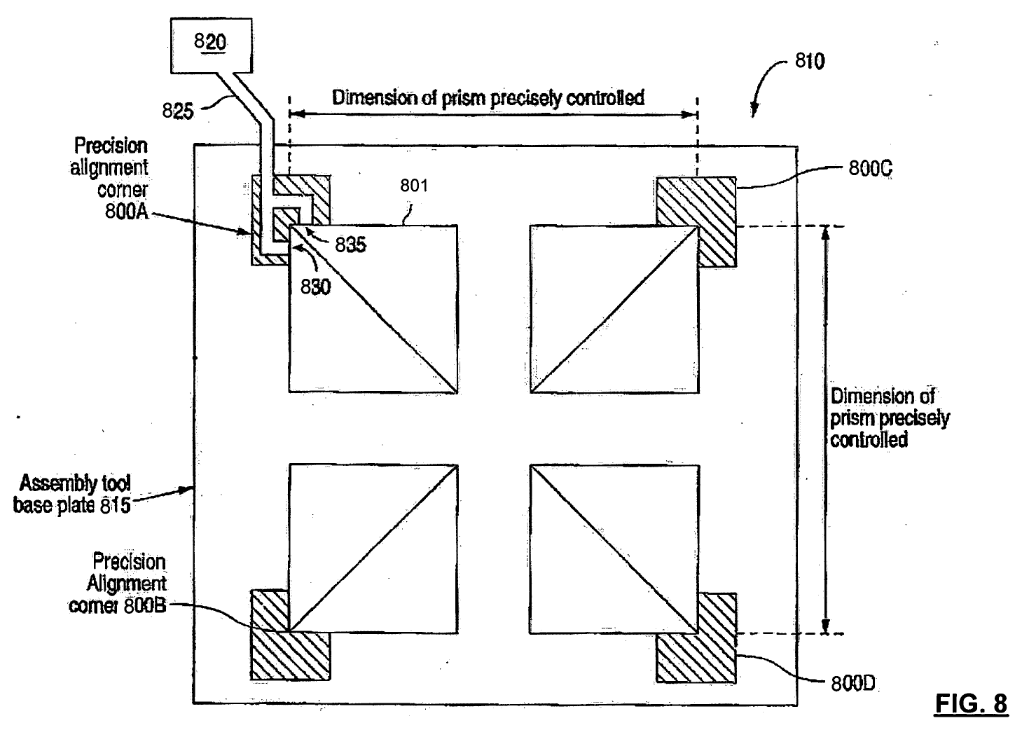

In several of the disclosed embodiments, the optical components are assembled from the “outside in”. As shown in FIG. 8, outside surfaces of each of four beam splitters in a prism assembly are accurately held in position by precision alignment corners 800A-D of an assembly tool 810. For example, outside surfaces of beam splitter 801 are held in a fixed position determined by alignment corner 800A.

The assembly tool includes a base plate 815 to which the precision alignment corners 800 are fixed. Construction of the alignment corners 800A, 800B, 800C, and 800D can be performed using mechanical tooling. The alignment corners are constructed to a tolerance and positioned on the assembly tool base plate such that they precisely fix the outside dimensions of each beam splitter. Each alignment corner includes a device for securing the PBS in position during assembly. For example, beam splitter 801 is held tight in alignment corner 800A via vacuum holders 830 and 835. The vacuum holders are connected to vacuum pump 830 via vacuum tube 825. In one embodiment, there is a single vacuum holder in the corner of the alignment corner.

The alignment corners provide the precise dimensional accuracy required to achieve pathlength matching in the prism assembly and is accomplished by mechanical tooling rather than expensive tightly toleranced optical components. However, pathlength matching alone does not produce an acceptable prism assembly. Although pathlength matched, because the optical components are of varying non-precise tolerances (different sizes), the PBS do not fit precisely together (e.g., intersection of PBS 710 and 714, and any dichroics or filters placed therebetween, do not fit exactly). An air gap is introduced between the internal optical surfaces of the PBSs which accounts for size variations in the PBSs and other prism assembly components. The air gap itself introduces other problems including refraction and other optical variations that should be reduced or eliminated.

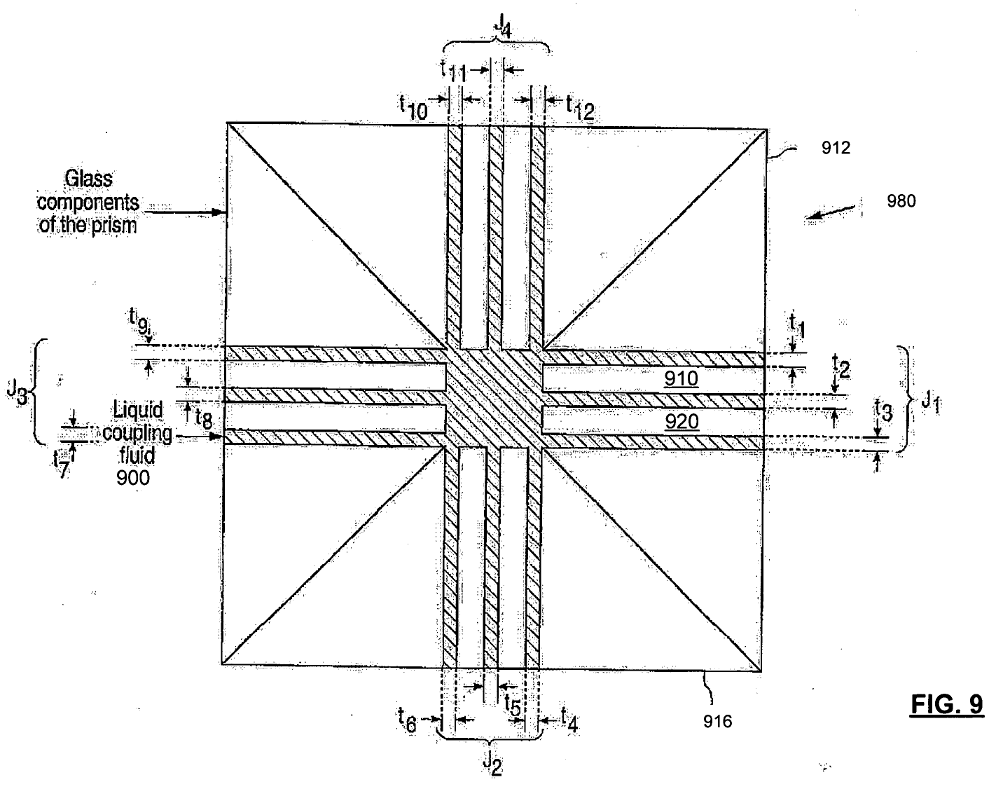

The present invention reduces the undesirable effects from the imprecisely fit PBSs by coupling the PBSs with a liquid. In one embodiment, all internal optical surfaces of the prism assembly are coupled using a liquid. FIG. 9 is a drawing of liquid coupling of components of a prism assembly according to an embodiment of the present invention. Between adjacent beam splitters is a joint that is filled with liquid. The thickness of the liquid filled joints is varied based on variations in size of the individual beam splitters and/or other optical components utilized in the prism assembly. The thickness of the liquid filled joints is also varied to maintain any desired exterior dimensions of the prism assembly and the desired matched pathlengths within the prism assembly. For example, Liquid filled joint J1, the joint between beam splitter 912 and beam splitter 916 comprises liquid between the beam splitters, the entire joint comprising the liquid coupling fluid 900 in spaces t1, t2, and t3, and dichroics and/or other optical elements placed between the PBSs (e.g., optical elements 910 and 920 placed between the PBSs). These and other optical elements may be, for example, any combination of dichroics, spacers, polarizers, or filters, depending on the particulars of the specific prism assembly design. Accommodating the optical elements in the liquid coupling fluid will prevent stress from building up in the optical elements and other components of the prism assembly. The beam splitters themselves may be PBSs, CBSs, a combination of both, or other beam splitting devices.

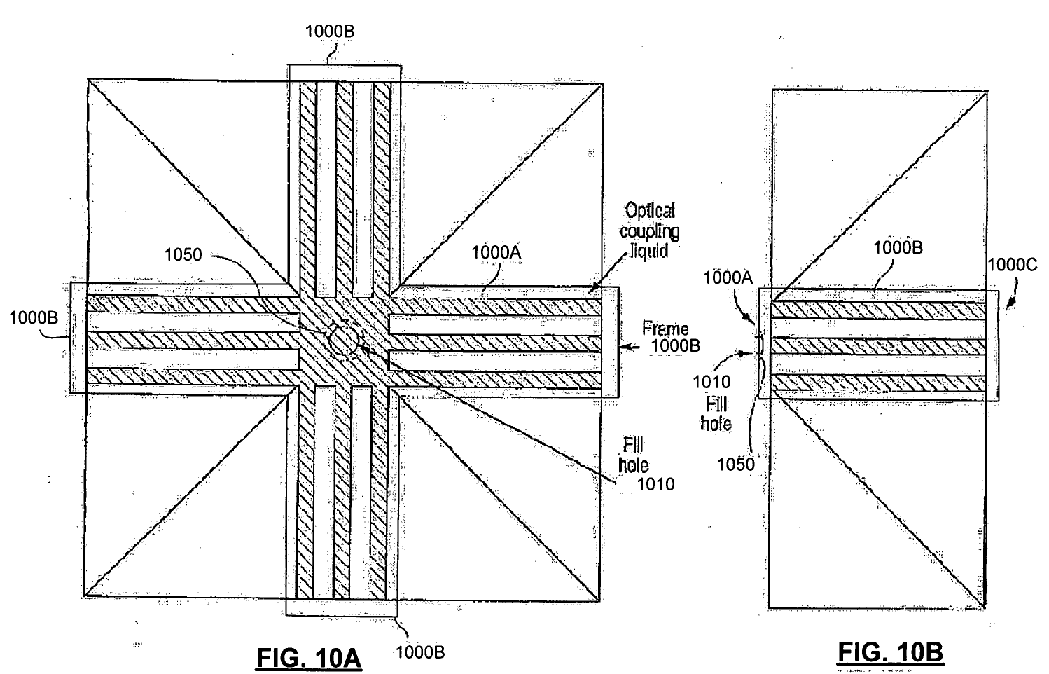

In one embodiment, a frame, glued to the external surfaces of the prism assembly, is used to contain the liquid and hold the components in place. FIG. 10 is a drawing of top and side views of a frame 1000 that holds components of a prism assembly according to an embodiment of the present invention. The frame 1000, which can be made of one or several pieces, and is placed over each of the joints between the PBSs. In this embodiment, the frame 1000 comprises 2 side components 1000A and 1000C, and 4 edge components 1000B. Each side component is a plus sign (+) shaped glass, plastic, acrylic, etc., or other material, each appendage of the plus sign covering a joint, and the middle of the plus sign covering the conjunction of all 4 joints. The edge components 1000B cover the edge of each of one of the joints. The top side component 1000A includes a fill hole 1010 to which fluid may be applied and/or added as needed. A cap (not shown) is used to cap off the fill hole to prevent spillage of the fluid. An air bubble 1050 is provided to compensate for liquid expansion/contraction and prevent stress build up on the optical components. The frame 1000 is illustrated as a plus sign shape, but may be completely rectangular or any other shape, so long as it covers each joint sufficiently. Glue or other adhesive applied to the frame creates a seal between the frame and the beam splitters so as to fully contain the coupling fluid. The glue or other adhesive also fixes the position of the beam splitters to the frame to assure non-movement of the PBSs with respect to each other (maintaining the monolithic nature of the prism assembly).

Using the adhesive between the frame and beam splitters to fix the matched pathlengths is performed by determining the matched pathlength positions of the prism assembly components (e.g., using a tool having corner pieces or other positioning devices to assure the correct optical pathlengths), and then gluing the components (e.g., PBSs) to one or more parts of the frame at those matched pathlength positions. Additional optical elements are then positioned in the joints (e.g., optical elements 910 and 920), the joints are then at least partly filled with optical coupling fluid (liquid coupling fluid), the joints are then capped with a top frame piece, and then the coupling fluid is topped off (except for the air bubble or other expansion air space), and then the fill hole is capped.

The joints are filled or topped off, for example, by injection from a syringe type device through a fill hole on the top frame piece. Capillary action between the optical elements and beam splitters in both vertical and horizontal directions will assist the filling process. In other embodiments, the same process occurs with the top portion of the frame in place, in which case the syringe is inserted through the fill hole to a bottom of the prism assembly, and then the prism assembly is filled with coupling fluid. Other devices including tubes, pumps, or other pouring mechanisms may be used to place the fluid in the prism assembly (e.g., using the fill hole).

Recognize that, if the components within the prism assembly were to directly touch (e.g., optical element 910 directly touching either optical element 920 or PBS 712), the result could be a visible artifact in an image projected by the prism assembly. The solution to this problem is to assure that a thin layer of liquid exists between the components and or elements of the optical assembly. Many different methods and/or devices may be implemented to assure that a layer of liquid exists between components. For example, the optical elements may be physically separated during filling of the coupling fluid, spacers may be affixed to portions of the frame to separate the elements and PBSs. Surfaces of the prism assembly components may be whetted with coupling fluid prior to assembly. In one embodiment, spacers are applied between the optical surfaces. The spacers can be glass rods or balls with diameter on the order of thousandths of an inch. The index of refraction of the liquid coupling fluid is chosen to be close to that of the spacers thus rendering them less visible.

The present invention includes various methods and devices for application of the spacers. In one set of embodiments, the spacers are applied directly to the optical surfaces of the PBSs and/or optical elements. In one embodiment, the spacers are sprayed onto the optical surfaces. Spraying spacers onto optical surfaces may be performed using liquid crystal display manufacturing techniques and machinery. Either wet or dry spacer application may be utilized. In other embodiments, the spacers are suspended in the liquid coupling fluid at least during manufacture. After manufacture of the prism assembly, suspended spaces remain lodged between the optical surfaces and/or settle to a bottom portion of the prism assembly out of the viewing area.

The liquid coupling fluid is an optical coupling fluid selected to have an index of refraction that matches (or closely matches) the index of refraction of the beam splitters and any optical elements spaced within the fluid. The index of refraction changes depending on wavelength, and is different for each of the components and elements in the prism assembly. Typical values are 1.52 for plastic elements, and 1.71 for glass components. The optical coupling fluid generally preferred to have an index of refraction in the 1.50-1.85 range. A 1.6 index of refraction optical coupling fluid has worked well in experiments carried out by the inventors. Similarly, in the embodiments using spacers, the optical coupling fluid is chosen to have an index of refraction preferably matching each of the PBSs, optical elements, and spacers as closely as possible. Matching the index of refraction can be done by splitting the difference between the index of refraction of the optical components and elements. Another method would be to perform an impedance matching type of arithmetic (e.g., taking the square root of the sum of the squares of the index of refraction of each optical component/element). However, the present inventors note that selection of any index of refraction between the high and low index of refraction of the optical components and elements is likely to provide better matching than any other embodiments of the pathlength matched prism assembly, including the gel, cured epoxy, and air filled embodiments discussed elsewhere herein. The chosen index of refraction of the coupling fluid may also be weighted toward matching component interfaces that occur more frequently in the prism assembly. In one embodiment, the index of refraction of the coupling fluid matches the index of refraction of the spacers.

Important properties for the coupling fluid are toxicity, flammability, yellowing propensity, chemical properties, and cost. Toxicity and flammability are safety considerations, the product is preferably non-toxic and non-flammable. Also, the optical coupling fluid, to be practical, needs to be resistant to yellowing, particularly under intense light and heat conditions. The optical coupling fluid has to have chemical properties that do not react with other optical elements, components, and parts of the prism assembly. And, to be commercially practical, the optical coupling fluid needs to be relatively inexpensive and readily available. In one embodiment, the, optical coupling fluid is, for example, mineral oil. Many different types and properties of optical coupling fluid are commercially available (e.g., Cargille Corp makes many different types of index matching fluid).

In one embodiment, the optical coupling fluid is a UV curing adhesive, which, when cured, makes a solid prism assembly, the cured adhesive coupling the optical elements/components without fluids. However, the liquid filled embodiments have better index of refraction matching than commercially practical UV curing adhesive, so the liquid filled embodiments are preferred. In another embodiment, optical coupling is performed by inserting an optical coupling gel between the various components/elements of the prism assembly. NYE Corporation makes one such gel (matching gel). In yet another embodiment, the coupling material is air, or another gas is utilized as a coupler between the optical components and elements. In the air-filled embodiment, anti-reflection coating are places on the surfaces of the optical elements and components to eliminate or reduce reflections.

Note that variations of the assembly techniques described herein can be applied to any of the prism assembly configurations discussed in this document.

There are several other advantages offered by the configuration and manufacturing method described above. These include the following:

Several prism assembly configurations include polarization-rotating component(s) (rotators) (e.g., rotating beam 735 after being passed by polarizing beam splitter thin film 717 so it is then reflected by polarizing beam splitter thin film 713). Rotators are generally constructed of layers of polycarbonate plastic bonded together. In prior systems, the adhesive needs to be able to bond the polycarbonate plastic of the rotator to the glass of the prism assembly components. A solution to this problem is to place the polarizing rotator in the form of a “sandwich”. In “sandwich” form, the rotator has been bonded or otherwise secured between two cover glasses by the rotator manufacturer. The cover glasses make it easier for the prism assembly manufacturer to bond the rotator into the prism assembly (e.g., bonding between surfaces of adjacent cover glasses). However, compared to the polycarbonate rotator itself, the sandwich may be more expensive. In contrast, in the present invention, The liquid coupling method allows the direct use of the inexpensive, readily available polycarbonate component. Since with liquid coupling the polycarbonate is not bonded with adhesive, this class of problems is eliminated.

The precise outside dimensions of the prism assembly obtained using the new manufacturing method not only allow direct mounting of the microdisplays onto the prism assembly, but also allows for the use of precision (or fixed) mounting points for mounting the completed kernel (prism assembly with microdisplays attached) into the device in which it is to be used (e.g., light engine). The use of precision or fixed mounting points reduces or eliminates the need for a physical adjustment mechanism and procedure when mounting the kernel into the light engine, reducing production costs.

Conventional prism assemblies generally utilize a series of glue cure steps. As the prism assembly grows in size and complexity, it becomes progressively more difficult to cure the adhesives due to the absorption of light by the glass and/or the optical properties of the components. Liquid coupling as provided by the present invention reduces the time required for assembly of the prism assembly.

The present invention includes a device and method to hold the optical elements (e.g., optical elements 910 and 920) in place. The optical elements are also generally referred to as planar components (or flats) because they are generally rectangular in shape and flat (having a thin width). However, the present invention may be practiced using different shapes and widths of the optical components.

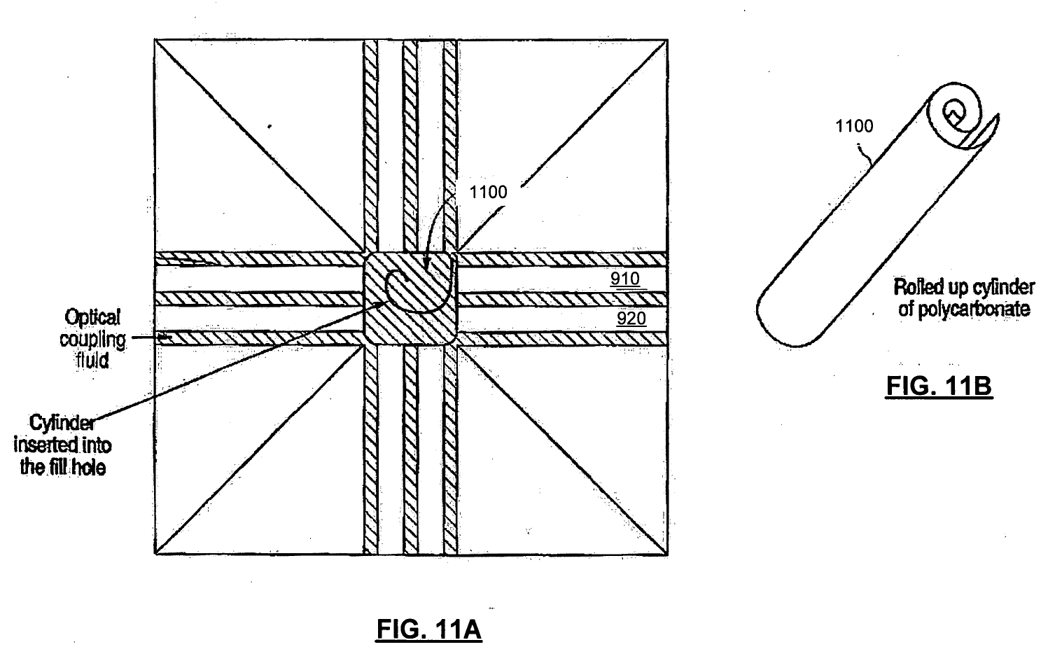

One concern at any time, including manufacture, shipping, storage, and/or during actual use is the potential movement of optical components in the coupling fluid. Movement towards the fill hole could potentially leave the moved component (or parts of the moved component) out of the optical path. The present invention provides for placing a spacer device in the fill hole to hold the planar components in a stable general location. FIG. 11 is a drawing of an example spacer device 1100 utilized to hold optical components, particularly the planar components, according to an embodiment of the present invention. In the illustrated embodiment, the spacer device 1100 is a sheet of polycarbonate rolled into a tight cylinder. The spacer device 1100 is inserted into the fill hole. Once in place, the cylinder will “unroll” and press on the components so as to keep them out of the fill hole.

As previously discussed an air bubble may be left inside the prism assembly to account for expansion of the various components. One problem with expansion of the components is that the components expand at different rates. As the optical coupling fluid expands, so does the optical components of the prism assembly however, the expansion of the liquid and optical components is at different rates (differential expansion). In most cases, the optical coupling fluid expands at a higher rate than the optical components. Without the air bubble, an amount of stress is applied against the optical components by the expanding fluid. Without the air bubble, this stress can cause an undesirable amount of stress induced birefringence effecting the various light beams passing through the optical components of the prism assembly as the liquid coupling fluid expand.

Referring back to FIG. 10, an air bubble 1050 is illustrated. The air bubble 1050 is permanently maintained within the prism assembly once the fill hole 1010 is capped. In FIG. 10, the “frame” elements (1000A, 1000B, and 1000C) on the outside of the prism assembly serve both to contain the liquid and to hold the prism assembly components (PBSs) rigidly in space.

In the example embodiment of FIG. 10, the volume within the prism assembly surrounded by frame 1000 is occupied by glass of the prism assembly components (e.g., PBSs), optical elements (e.g., planar components), and the optical coupling liquid. As the temperature of the prism assembly rises (as it will during operation) the linear and volume dimensions of all components increase. However, at least partly due to the fact that the coefficient of thermal volumetric expansion of the optical coupling liquid is considerably higher than that of the glass and other materials, when the temperature rises, the volume of the liquid expands faster that that of the glass “container” (optical components and frame bounding the liquid). In addition to the undesirable optical effects, excessive stress caused by this differential expansion could potentially cause the bonded components to separate. The air bubble 1050 is one way to accommodate the effects of differential expansion and avoid the build up of stress.

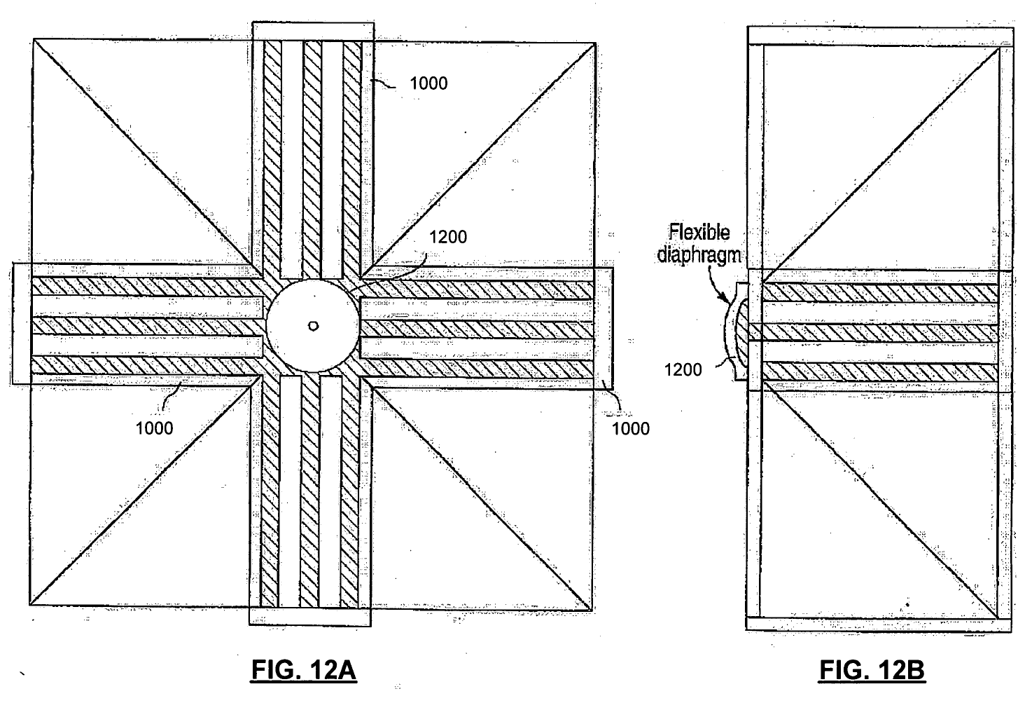

FIG. 12 is a drawing of a prism assembly equipped with a diaphragm 1200 according to an embodiment of the present invention. The diaphragm 1200 is constructed of a flexible material such as rubber, plastic, or another material with sufficient strength and flexibility to accommodate the expanding fluid and thereby relieve stress. The diaphragm 1200 flexes as the volume of liquid increases or decreases. Preferably, the diaphragm 1200 is circular and affixed over the fill hole 1010 using an adhesive. However, other shapes and attachment mechanisms may be utilized (e.g., the flexible material fitted under a ring clipped to the frame around the fill hole).

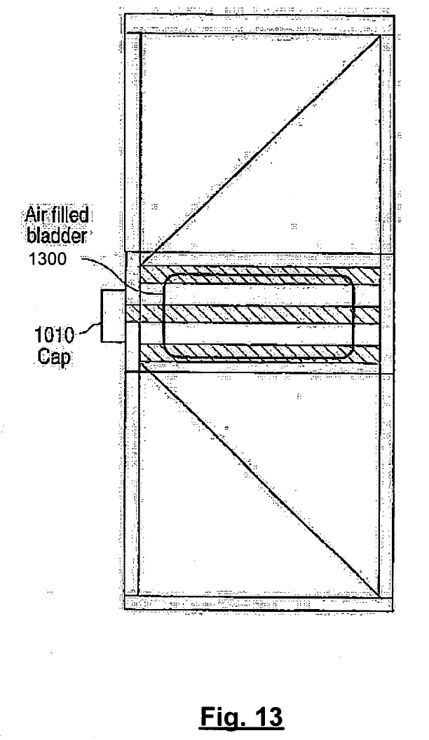

FIG. 13 is a drawing of an air bladder 1300 equipped prism assembly according to an embodiment of the present invention. In one embodiment, the frame 1000 is capped (e.g., cap 1310), and a bladder is inserted inside the optical assembly. The bladder expands and contracts as the volume of liquid decreases and increases.

The air filled bladder 1300 is inserted into the conjunction of beam splitters under the fill hole. The volume of the bladder can increase or decrease to accommodate volumetric changes in the coupling liquid. In alternative embodiments, the bladder may be filled with any suitably compressible material (e.g., gas, solid, or combination thereof). The bladder 1300 can also serve to assist in holding those components in place that are not glued to the frame (e.g., the planar components (e.g., 910, 920) located between the polarizing beam splitting cubes). When configured to assist in holding the planar components in place, spacers such as polycarbonate roll 1100 may not be needed.

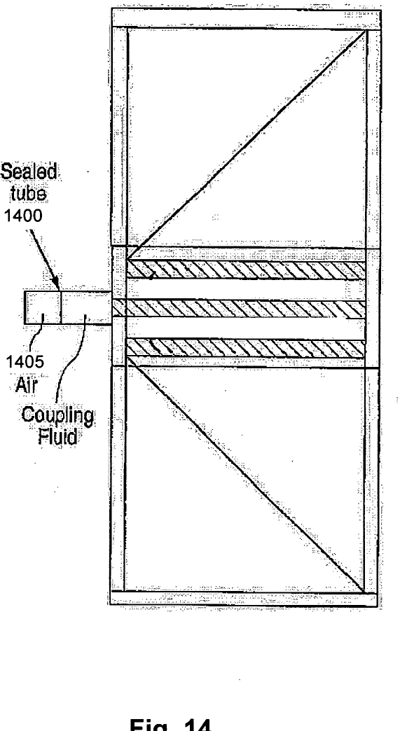

FIG. 14 is a drawing of an embodiment of a sealed tube 1400 assembly according to an embodiment of the present invention. A sealed tube 1400 is shown attached to the fill hole 1010. A portion of the sealed tube 1400 contains an air bubble 1405. The air bubble 1405 will enlarge or shrink to accommodate expansion or contraction of the liquid within the prism assembly. In this approach, similar to the air bubble only approach discussed above, it is important to understand the orientation of the prism assembly in the light engine application. The reason being that the air bubble 1100 will migrate to the highest point within the prism assembly. It is therefore necessary to design the system such that the end of the tube is a high point. The tube may be conf igured with an elbow or other structure to direct the air bubble to an appropriate location. In the case of the air bubble only approach, it is therefore important that the high point of the prism assembly (high point of fluid in the prism assembly) is not at a point in of the optical paths of the prism assembly.

Each of the above embodiments have an external frame (e.g., frame 1000—external to the optical components of the prism assembly) that seals the prism assembly and contains the optical coupling fluid (and include any necessary attachments for any of the stress relief features discussed above). The frame also provides structural strength to the prism assembly. However, the present inventors have also realized the need for a compact arrangement for sealing the optical coupling fluid. The compact arrangement then allows for the prism assembly to be utilized in a wider variety of optical applications, including different LCOS based video projection systems.

Furthermore, any newly designed and/or previously existing light engine systems can be fitted with a liquid coupled prism assembly. In new designs, fitting the liquid coupled prism assembly may be performed by fitting mounts within the projection system to accommodate one or more liquid coupled prism assembly sizes. However, in the case of retrofit systems (fitting liquid filled prism assemblies to previously sold projection systems and/or fitting liquid coupled prism assemblies to new projection system of a previous design), physical accommodation of the liquid coupled prism assemblies may not be so easily accomplished. That is, the physical size and shape of a fluid coupled prism assembly may not allow it to directly fit into the position provided for a conventional prism assembly within an existing light engine. The modifications of the light engine required to accommodate a fluid coupled prism assembly may be difficult, expensive or, in an extreme case, not possible. Therefore, by providing a fluid coupled prism assembly that is sealed and provides structural strength and has external dimensions that are similar to that of an equivalent conventional prism assembly, that prism assembly could be used as a drop in replacement for a conventional prism assembly in any light engine design. The inventions disclosed in this document have this type of capability.

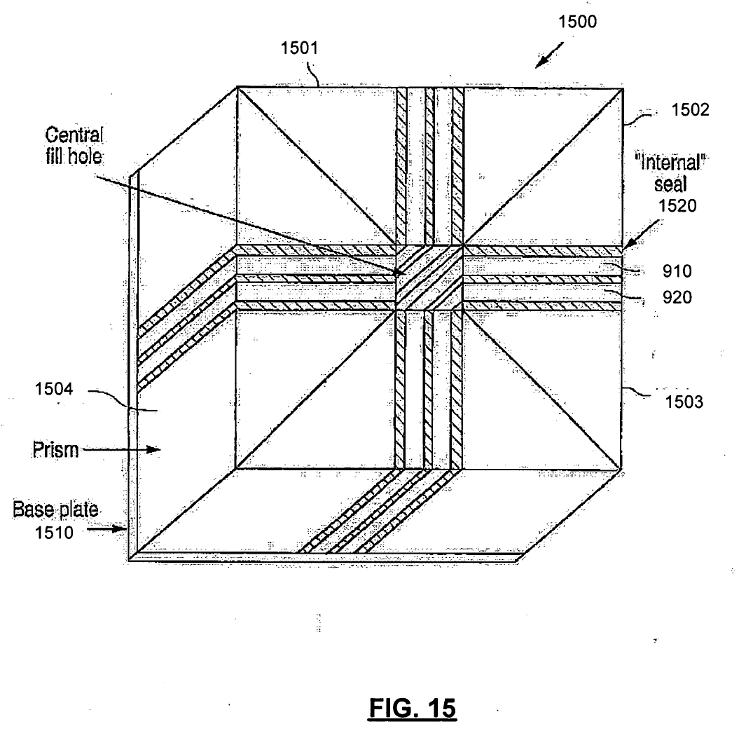

For these and other reasons the present inventors have also developed an internally sealed prism assembly that seals and provides structural integrity to a liquid filled prism assembly. FIG. 15 is a drawing of an internally sealed prism assembly 1500 according to an embodiment of the present invention. The internally sealed prism assembly 1500 includes a baseplate 1510 and at least one internal seal 1520 between optical components of the prism assembly. Comparing this embodiment to the previous configurations, most features of the external frame are absent except the base plate 1510 (the base plate being a feature common to both the conventional and fluid coupled prism assembly configurations). The base plate 1510 provides a secure, firm surface for attaching the beam splitters 1501-1504. As illustrated in FIG. 15, the internal seal is fitted between optical elements 910 and 920, between optical element 910 and beam splitter 1502, and between optical element 920 and beam splitter 1503. The internal seal extends downward from the top of the optical elements/beam splitter a short distance (e.g., 1 mm) to produce a seal that maintains the optical coupling fluid installed into the prism assembly. In one embodiment, the internal seal also overlaps the tops of the optical elements (e.g., 910 and 920), such that the seal covers the exposed surfaces of the optical elements, but preferably does not extend beyond the outer surface of the beam splitters. In depth, the seals seeps between the optical elements/beam splitters to a prescribed sealing depth (e.g., 1 mm).

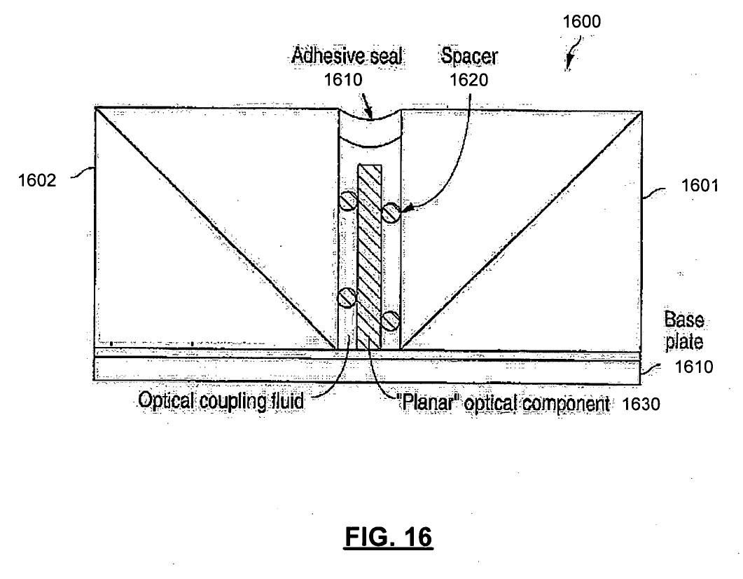

FIG. 16 is a close-up of an internal seal of an internally sealed prism assembly 1600 (part view) according to an embodiment of the present invention. In FIG. 16, 2 beam splitters 1601 and 1602 have an internal seal 1610 between them. The internal seal may be described as a “picture frame” between the beam splitting elements. The adhesive does not extend beyond the outer surface of the prism assembly. Preferably, the internal seal is an adhesive agent that not only seals the prism assembly, preventing leakage of the optical coupling fluid, but may also provide additional rigidity to the entire structure. The adhesive may be, for example a 1 or 2 part epoxy or a UV cured adhesive that both hardens and seals.

Alternatively, the adhesive seal may be a pliant adhesive such as silicone based adhesives. However, flexing of the prism assembly can become an issue if non-hardened sealant is utilized. While the bottom plate of the frame provides enough rigidity that pliant adhesives may be acceptable in some applications, a top plate (on the side of the prism assembly opposite the base plate) in addition to the base plate adds enough rigidity that pliant adhesives are fully acceptable in most all applications.

FIG. 16 also illustrates an optical element (“Planar” optical component 1630) separated by spacers 1620. The optical element is shorter than a bottom height of the adhesive sealant. The optical element is representative and may in fact be several optical elements also separated from the beam splitters and each other via additional spacers. The “planar” optical components 1610 are items such as dichroics, reflective polarizers and wavelength specific retarders contained between the PBSs and suspended in the optical coupling liquid. The planar components are, for example, spaced from the glass surfaces by use of spacer elements as discussed previously. Penetration (the prescribed sealing depth) of the adhesive 1410 is confined to a region out of the optical path. The base plate 1310 provides the required rigidity to the prism assembly.

As explained above, the principle advantages of the disclosed liquid coupled prism assembly techniques and configurations include the ability to use less expensive, low tolerance glass components, and the ability to fabricate a prism assembly with “perfect” outside dimensions and in so doing, enabling the attachment of microdisplays directly to the prism assembly. In turn, the latter provides several advantages the foremost being that the resulting monolithic assembly will remain in a alignment under a wide range of conditions.

An alternative means by which these advantages can be obtained is to utilize the “build from the outside in” procedure described previously but, rather than filling the prism assembly with an optical coupling liquid, leaving the assembly empty therefore “filling” with air. In this approach, all surfaces now exposed are coated with an anti-reflection thin film (AR coatings) to suppress reflections. The expansion port is not required in this configuration. In some applications it may be possible to also omit the side rails of the frame (e.g., 1000B) and possibly the top (1000C).

In yet another alternative, the prism assembly is filled with an epoxy that cures. Preferably the cured epoxy has an index of refraction that closely matches the index of refraction of the PBSs and optical elements utilized. In still yet another embodiment, a gel substance may also be used to fill the joints between adjacent beam splitters. Again, preferably, the gel has an index of refraction that approximates that of the other parts of the prism assembly. An example gel that could be utilized is manufactured by NYE Corporation.

The present invention includes both Polarizing Beam Splitting (PBS) devices and Cholesteric Beam Splitting (CBS) devices constructed as pathlength matched beam splitters. The beam splitters split an input light beam into two component light beams. For example, the PBSs discussed above split an unpolarized input beam into S and P polarized light beams. Hence the PBS is referred to as a polarizing beam splitter because each of the component light beams produced from the splitting are polarized. Looking back at FIG. 3, the CBS 350 splits M-RHCP light into a B-RHCP light beam and a R-RHCP light beam.

Pathlength matching in a beam splitter may be defined as a beam splitter in which the pathlengths within the beam splitter are matched. That is, for a selected light beam entering the beam splitter, one portion of the light beam is reflected off the beam splitting layer (e.g., polarizing thin film, or cholesteric, depending on the beam splitter design), and another portion of the light beam is transmitted through the beam splitting layer. The pathlength of the split portion of the light beam within the beam splitter, and the pathlength of the transmitted portion of the light beam within the beam splitter are equivalent (matched), hence a pathlength matched beam splitter.

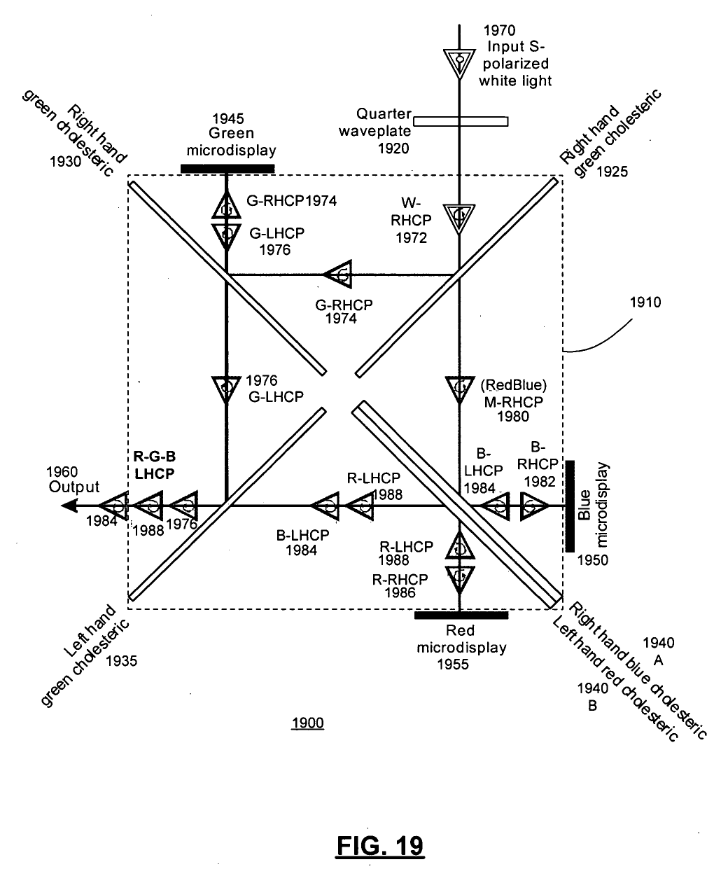

Beam splitters can be designed that do not have the structure of two prisms. Looking ahead to the example of FIG. 19, beam splitting layers (thin film, coating, etc) are deposited on a supporting substrate (e.g., glass). Pathlength matched beam splitting in the context of FIG. 19 is roughly equivalent to pathlength matched beam splitting elements disposed on diagonals of prisms in that the thin films are positioned so that the pathlengths of the reflected beam and the transmitted beam travel the same distances to corresponding pathlength matched reference planes, which may be, for example, the boundary of the next optical element in the prism assembly.

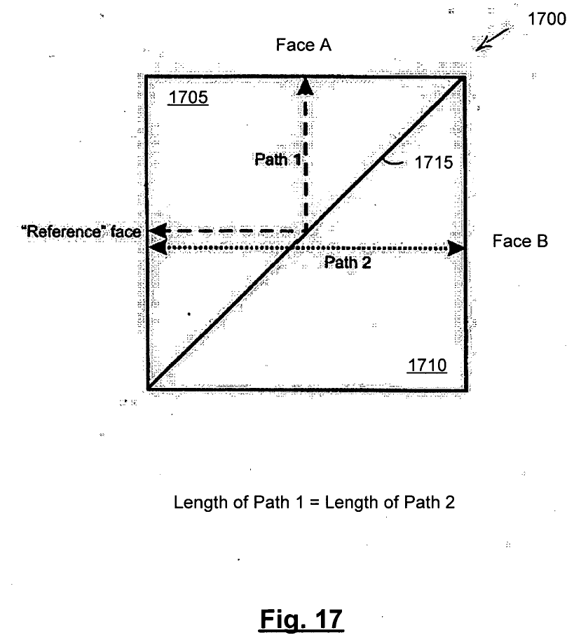

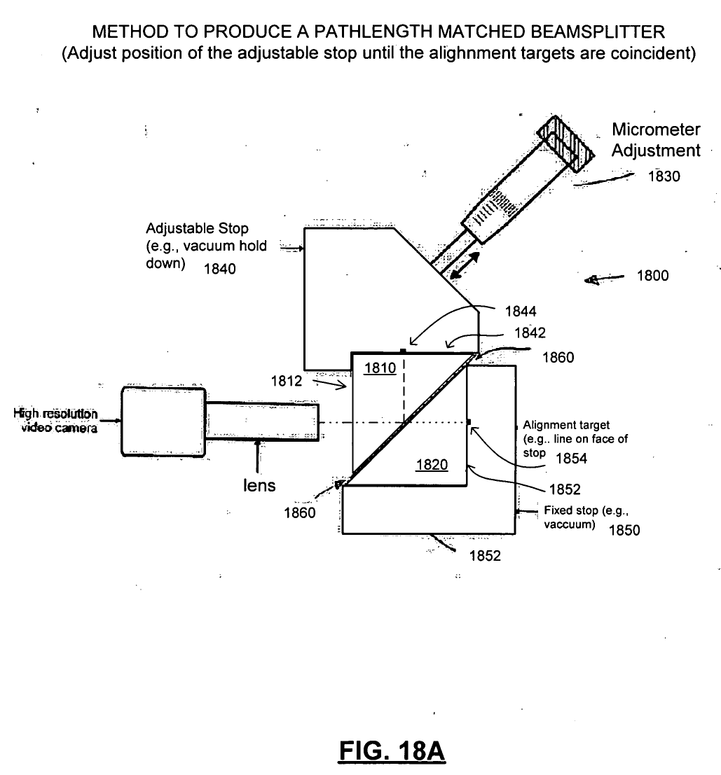

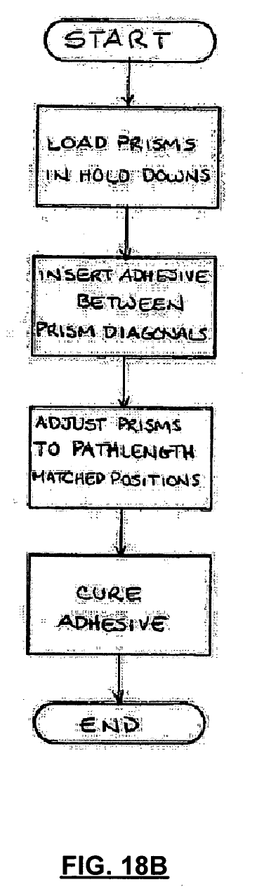

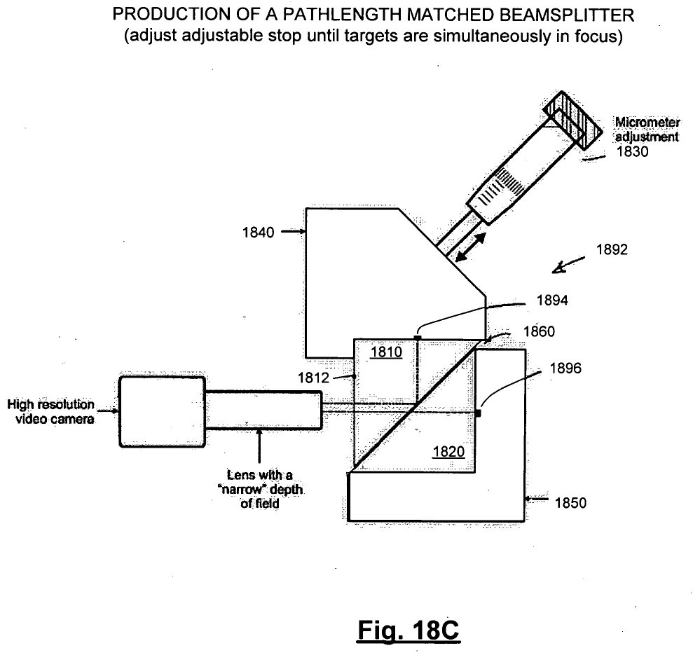

The concept of pathlength matching is illustrated in FIG. 17 (Path 1=Path 2) in a Beam Splitting Cube 1700. Beam Splitting Cube 1700 comprises 2 prisms, an upper prism 1705 and a lower prism 1710. The prisms 1705 and 1710 are joined at a common diagonal 1715. The Beam Splitting Cube 1700 has 2 illustrated paths, path 1 from a Face A of prism 105 to a Reference face of prism 105, and, path 2 from a Face B of prism 1710 to the Reference face of prism 1705. The illustrated paths are physical pathlengths that are substantially equal. Ideally, the pathlengths are exactly equal, which results in the horizontal portions of the paths through prism 1705 being coincident (coincident paths are, for example, illustrated in FIG. 18A as a dashed and dotted line entering the beam splitter). Hence, optical pathlengths at a given wavelength along the same paths are also substantially equal.

The final result is that for an individual beam of light passing through the beam splitter (e.g., the dashed and dotted line in FIG. 18A), part of the individual light beam is reflected and part of the individual light beam is passed by the beam splitting layer between the two prisms. The reflected portion of the individual light beam (e.g., the dashed only line in FIG. 18A) and the transmitted portion of the individual light beam (e.g., the dotted only line in FIG. 18A) travel the same distance within the beam splitter. Hence, a pathlength matched beam splitter, also referred to as pathlength matching in a beam splitter and others (e.g., beam splitter pathlength matched positions, beam splitter pathlength matching, etc).

Different methods to produce a pathlength matched beam splitter are provided. One method is to measure the dimensions of all prism components and to sort them into groups having identical dimensions. Only prisms drawn from the same group would be mated. This method can produce a pathlength matched beam splitter but requires the additional labor associated with the measurements and provides additional opportunity to damage delicate prism surfaces. In addition, implementation of this method requires maintaining a substantial inventory of prism components to support high volume manufacturing.

Another method is to measure the physical dimensions of the beam splitter during the assembly process. Then, the dimensions of the beam splitter are modified by adjusting a thickness of the glue line. The glue line is along the diagonal of the two prisms. In practice, this fabrication method is found to be slow, require considerable operator skill, and provides a poor yield.

Referring now to FIG. 18A, there is illustrated a pathlength matching device 1800 used to produce a pathlength matched beam splitting cube. A production process of the pathlength matched beam splitting cube is now described.

The pathlength matching device 1800 is configured to hold two prisms (e.g., prism 1810 and 1820) and provide a fine adjustment (e.g. micrometer adjustment 1830) for aligning or matching selected pathlengths through the two prisms. The two prisms (1810 and 1820) that will compose a pathlength matched beam splitter upon completion of the production process are positioned onto precision “stops” (1840 and 1850) of the pathlength matching device 1800. Using the terminology defined in FIG. 17, Face A (on the top prism 1810) is attached to the adjustable stop 1840 along side 1842 of the adjustable stop, and Face B (on the side of prism 1820) is attached to the fixed stop 1850 along side 1852 of the fixed stop.

One method to achieve a firm but temporary attachment of the prisms to the stops is to use a vacuum hold down. For example, a vacuum chuck (not shown) is placed in at least one location on each stop and a vacuum line attached to the chucks provides suction that holds the prisms in place onto the stops. However, other devices such as a clamp may be utilized. Thus the prisms are placed in position in corresponding stops of the pathlength matching device.

An adhesive (e.g., a UV curable adhesive) is dispensed to fill the gap between the top and bottom prism. On the face of each stop is a precisely located alignment target (e.g., alignment targets 1854 and 1844). The alignment target is a fine line (on the order of 10 microns). Stop 1840 includes alignment target 1844 and stop 1850 includes alignment target 1854. A high-resolution video camera “looks into” the as yet unassembled beam splitter through a Reference Face 1812 of prism 1810. Both alignment lines are observed through the video camera. Pathlength matching is achieved when the two alignment lines coincide. The lines can be made coincident by “sliding” the top prism along diagonal 1860 between the top prism 1810 and the bottom prism 1820.

The amount of adjustment is performed by visually viewing and adjusting the beam splitter. With experience, an assembler will be able to estimate an amount of adjustment and dial that amount into the micrometer, and then perhaps make one or two smaller adjustments to position the prisms in a pathlength matched position. However, knowledge of a precise number to dial into the micrometer is not essential, and the pathlength matched position can be reached simply by viewing and adjusting. Therefore, the micrometer 1830 may be replaced by a fine adjustment screw or any device that can be configured to move the relative positions of the two prisms along their diagonals.

Also, note that the pathlength adjustment is fine tuned by sliding the prisms along their diagonals, and since the prisms are generally not of precisely the same dimensions, the prism corners will not perfectly align (note overhand at each end of the diagonals). In the finished pathlength matched beam splitter (e.g., PBS), the amount of overhang is proportional to an amount of non-uniformity, or non-equality, in the dimensions of the prisms. With uniform prisms having equal dimensions, the prisms would mate together evenly, however, as noted above, such precision in prism construction is very costly. Thus, the present invention allows pathlength matched construction without the need for precisely sized prisms.

In the embodiment of FIG. 18, a micrometer 1830 is utilized to adjust the position of the top prism and make the alignment lines coincide. In one embodiment, an operator watches an output of the video camera on a display screen and manually turns the micrometer adjustment until the alignment targets coincide. In another embodiment, the video camera feeds a computing device having vision system software that recognizes when the alignment targets are aligned. Computer generated signals inform an operator how much to adjust the micrometer, or the micrometer is adjusted by a stepping motor (or other control motor) as commanded by the vision system. In another embodiment, the video camera is replaced with an eyepiece in which the operator directly observes the alignment targets and then manually adjusts the micrometer 1830.

Finally, once alignment is satisfactory, a UV lamp is used to illuminate the beam splitter, curing the adhesive and locking the components into place. A process for producing a pathlength matched beam splitting cube is illustrated in FIG. 18B. To produce a Polarizing Beam Splitter (PBS) an additional step of applying a polarizing layer, a thin film for example, to a diagonal of one of the prisms or between each of the diagonals of the prisms is added. Other types of beam splitters may be constructed by adding or substituting a different thin film (e.g., colorized beam splitter by using a color layer). In one embodiment, a cholesteric layer as described above is applied to one of the prism diagonals. In another embodiment, two cholesteric layers are applied to one of the prism diagonals. In yet another embodiment, two cholesteric layers are applied, a first cholesteric layer to the diagonal of prism 1810 and a second cholesteric layer to the diagonal of prism 1820. The cholesteric layer itself may be comprised of one or more layers.

A second method of production of a pathlength matched PBS beam splitter is now described. FIG. 18C is an illustration of a device used to produce a pathlength matched beam splitter according to another embodiment of the present invention. Two prisms are held onto precision stops 1840 and 1850. Face A is attached to the adjustable stop 1840 and Face B is attached to the fixed stop 1850. Again, a vacuum hold down may be used to achieve a firm but temporary attachment of the prisms to the stops. As before, an adhesive (e.g., a UV adhesive) is dispensed to adhere the top and bottom prism along diagonal 1860.

An alignment target is located on the face of each stop. In this embodiment, the location of the alignment target need not be precise. A high-resolution video camera “looks into” the as yet unassembled beam splitter through the Reference Face 1812 (of the top prism 1810). In this embodiment, the depth of field (DOF) of the video camera (as determine by the lens) is chosen to be very limited. The position of the top prism is adjusted by micrometer 1830 until the video camera has both alignment targets simultaneously in focus. An equal distance (matched pathlength) from both alignment targets to the reference face (and video camera focal plane) is achieved when both alignment targets 1894 and 1896 are in focus. DOF of the video camera is limited such that the alignment targets can only be simultaneously in focus when the prisms are arranged in a pathlength matched position within a tolerance needed for a product in which the beam splitter is to be used. As before, when alignment is satisfactory, the final step is to cure the adhesive (e.g. illuminate with a UV lamp).

Pathlength matched beam splitters produced by any of the above described methods include all beam splitters using all varieties of beam splitting elements, including, but not limited to polarizing beam splitting elements (e.g., layers, thin films, etc.), cholesteric layers, dichroics, reflective polarizers, and other selectively reflective layers. In addition, the beam splitting element may be a single layer applied to one optical element (e.g., a prism), or multiple layers applied to a single or multiple optical elements. The techniques described may also be applied to beam splitters constructed from non-prism optical elements, and, in several described embodiments, their construction may be broadly described as using either alignment targets and/or focusing targets to match pathlengths.

FIG. 19 is a drawing of a kernel 1900 according to an embodiment of the present invention. The kernel 1900 includes a prism assembly 1910 and “red,” “green,” and “blue” microdisplays that are positioned to respectively modulate each of red, green, and blue light beams directed through the prism assembly by the various optical components of the prism assembly 1910. The “red” microdisplay is so described because it operates on red light, but it is otherwise, for the purposes of the present invention, equivalent to the other microdisplays of the kernel 1900.

The prism assembly 1910 is configured for the input of S polarized white light. A quarter waveplate 1920 converts input S polarized white light 1970 to right hand circularly polarization, resulting in white right hand circularly polarized (W-RHCP) light 1972.

The W-RHCP light 1972 is incident upon a right hand green (RHG) cholesteric 1925. The RHG cholesteric 1925 reflects a green portion of the W-RHCP light 1972 matching a bandwidth of the RHG cholesteric 1925, and the remaining wavelengths are transmitted (Red Blue (RB)—RHCP light 1980 is transmitted).

The G-RHCP light 1974 is then incident upon a right hand green (RHG) cholesteric 1930, which reflects the G-RHCP light 1974 toward a “green” microdisplay 1945. One or more quarter waveplates in each light channel (not shown) are utilized for any one or more of residual retardation compensation, skew ray compensation, circular and linear polarization conversions in a manner similar to that previously discussed.

The “green” microdisplay is energized with data corresponding to a green portion of a color image (e.g., video) and modulates and reflects the incident light. In [modulating] [reflecting] the polarization of the incident light is changed. In this example, the G-RHCP light 1974 incident upon the microdisplay 1945 is changed to green left hand circularly polarized (G-LHCP) light 1976 during [modulation] [reflection]. The modulated G-LHCP light 1976 then passes through the RHG cholesteric 1930 enroute to a left hand green (LHG) cholesteric 1935. Finally, the modulated G-LHCP light 1976 is reflected by the LHG cholesteric 1935 toward output 1960.

The RB-RHCP light 1980 is transmitted through RHG cholesteric 1925 and is incident upon right hand blue (RHB) cholesteric 1940A. A blue component (B-RHCP 1982) of the RB-RHCP light 1980 within a bandwidth of RHB cholesteric 1940A is reflected toward “blue” microdisplay 1950. Microdisplay 1950 modulates and reflects the blue component (now modulated blue left hand circularly polarized light B-LHCP 1984), which passes through the RHB cholesteric 1940A and a left hand red (LHR) cholesteric 1940B enroute toward the LHG cholesteric 1935.

A red component (R-RHCP 1986) of the RB-RHCP light 1980 passes through both the RHB cholesteric 1940A and the LHR cholesteric 1940B enroute to “red” microdisplay 1955. The microdisplay 1955 modulates and reflects the red component (now modulated red left hand circularly polarized (R-LHCP) light 1988), which is then reflected off the LHR cholesteric 1940B. The reflected modulated R-LHCP light 1988 is combined with the B-LHCP light 1984, and each of which then pass through the LHG cholesteric 1935. The combined modulated B-LHCP light 1984 and modulated R-LHCP light 1988 are then combined with the modulated G-LHCP 1976 as they proceed toward the output 1960.

In one embodiment, the cholesteric layers in FIG. 19 are supported by glass or another transparent substrate. In another embodiment, the cholesteric layers are supported on one or more prisms similar to beam splitting layers in beam splitters described elsewhere herein.

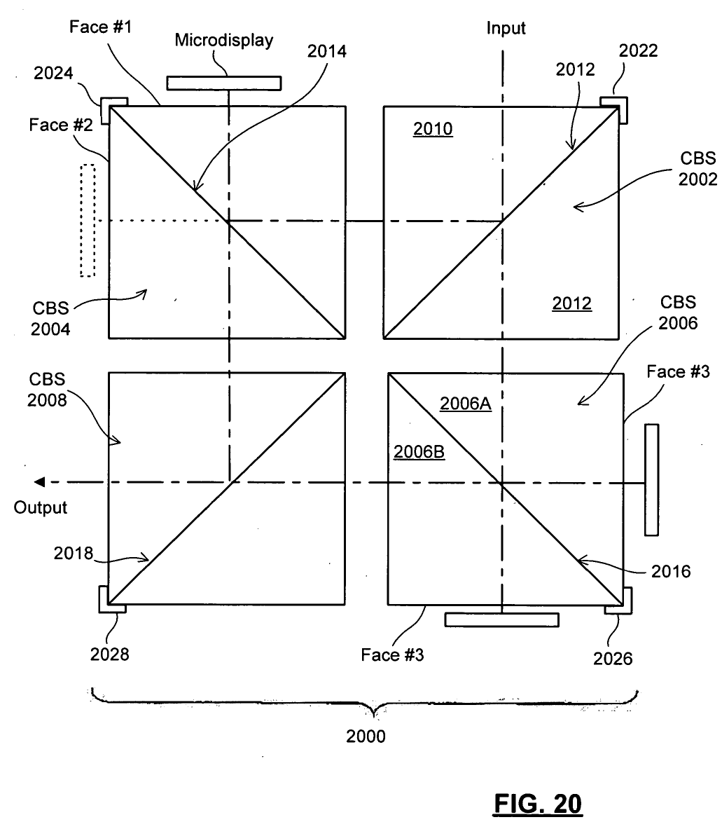

FIG. 20 is a drawing of an embodiment of the present invention that utilizes some of the above describes construction techniques to produce a pathlength matched prism assembly 2000 based on cholesteric reflectors. The prism assembly 2000 is constructed similarly to the PBS based prism assemblies discussed above, beam splitters set in pathlength matched positions (e.g., pathlengths for corresponding pixels from each of the “red,” “green,” and “blue” microdisplays to the output are equivalent), and coupled using an optical coupling fluid. Preferably, the prism assembly 2000 includes a compensator, such as an air bubble or flexible diaphragm to compensate for differential expansion of the coupling fluid and other prism components. The cholesteric based pathlength matched prism assembly 2000 includes 4 beam splitters 2002, 2004, 2006, and 2008.

The beam splitters 2002-2008 utilize cholesteric based reflectors, and may be referred to as Cholesteric Beam Splitters (CBS). Each of the CBSs include at least one cholesteric layer. For each beam splitter, the cholesteric layer is applied to at least one diagonal of the triangular prisms (e.g., prisms 2010 and 2012) that comprise the optical components of the beam splitter.

In the designs applicable to FIG. 20, one of the CBSs includes two cholesteric layers. The two cholesteric layers are, for example, applied one each to the two diagonals of the prisms that comprise the optical components of the beam splitter. That is, for example, in one embodiment, CBS 2006 includes 2 cholesteric layers, which may be embodied as a first cholesteric layer applied to the diagonal of prism 2006A and a second cholesteric layer applied to the diagonal of prism 2006B. The prisms with cholesteric layers are fitted together (e.g., bonded with an optical adhesive). Alternatively, both cholesteric layers may be applied to one of the prisms before assembly of the beam splitter.

The selection of which beam splitters contain one cholesteric layer and which beam splitter contains two cholesteric layers is dependent upon the design of the prism assembly. Also dependent upon an individual design is the handedness and color (or bandwidth) of each cholesteric layer.

A sample of potential designs using cholesteric layers are described with reference to FIG. 20 in Table 1. As shown in the table, the input may be either Right Hand or Left Hand circularly polarized white light.

TABLE 1

| | Face | CBS | CBS | Face | Face | CBS | Face | CBS |
|---|---|---|---|---|---|---|---|---|
| Input | #1 | 2002 | 2004 | #2 | #3 | 2006 | #4 | 2008 |
| W-RHCP | Green | RHG | RHG | — | Red | RHB + LHR | Blue | LHG |
| W-RHCP | Green | RHG | RHG | — | Blue | RHR + LHB | Red | LHG |
| W-RHCP | — | RHG | LHG | Green | Red | RHB + LHR | Blue | LHG |
| W-RHCP | — | RHG | LHG | Green | Blue | RHR + LHB | Red | LHG |
| W-RHCP | Blue | RHB | RHB | — | Red | RHG + LHR | Green | LHB |
| W-RHCP | Blue | RHB | RHB | — | Green | RHR + LHG | Red | LHB |
| W-RHCP | — | RHB | LHB | Blue | Red | RHG + LHR | Green | LHB |
| W-RHCP | — | RHB | LHB | Blue | Green | RHR + LHG | Red | LHB |
| W-RHCP | Red | RHR | RHR | — | Blue | RHG + LHB | Green | LHR |
| W-RHCP | Red | RHR | RHR | — | Green | RHB + LHG | Blue | LHR |
| W-RHCP | — | RHR | LHR | Red | Blue | RHG + LHB | Green | LHR |
| W-RHCP | — | RHR | LHR | Red | Green | RHB + LHG | Blue | LHR |
| — | — | — | — | — | — | — | — | — |
| W-LHCP | Green | LHG | LHG | — | Red | LHB + RHR | Blue | RHG |
| W-LHCP | Green | LHG | LHG | — | Blue | LHR + RHB | Red | RHG |
| W-LHCP | — | LHG | RHG | Green | Red | LHB + RHR | Blue | RHG |
| W-LHCP | — | LHG | RHG | Green | Blue | LHR + RHB | Red | RHG |
| W-LHCP | Blue | LHB | LHB | — | Red | LHG + RHR | Green | RHB |
| W-LHCP | Blue | LHB | LHB | — | Green | LHR + RHG | Red | RHB |
| W-LHCP | — | LHB | RHB | Blue | Red | LHG + RHR | Green | RHB |
| W-LHCP | — | LHB | RHB | Blue | Green | LHR + RHG | Red | RHB |
| W-LHCP | Red | LHR | LHR | — | Blue | LHG + RHB | Green | RHR |
| W-LHCP | Red | LHR | LHR | — | Green | LHB + RHG | Blue | RHR |
| W-LHCP | — | LHR | RHR | Red | Blue | LHG + RHB | Green | RHR |
| W-LHCP | — | LHR | RHR | Red | Green | LHB + RHG | Blue | RHR |

FIG. 17 may be referred to as a straight through prism assembly design.

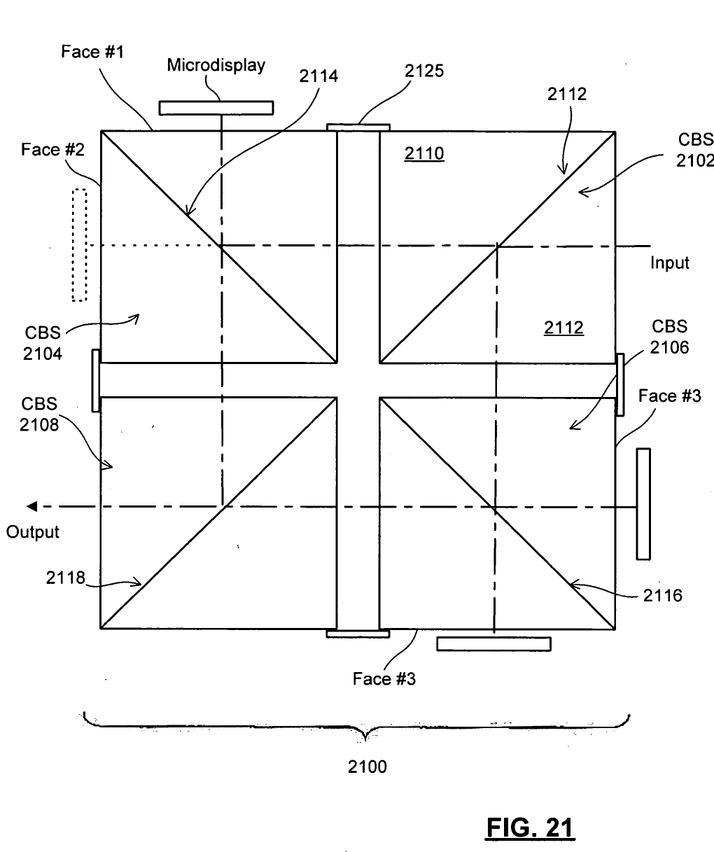

FIG. 21 may be referred to as a right angle prism design. The right angle prism design of FIG. 21 is also constructed using one or more of the techniques discussed above. A sample of potential designs using cholesteric layers are described with reference to FIG. 21 in Table 2.

TABLE 2

| | Face | CBS | CBS | Face | Face | CBS | Face | CBS |
|---|---|---|---|---|---|---|---|---|
| Input | #1 | 2102 | 2104 | #2 | #3 | 2106 | #4 | 2108 |
| W-RHCP | Green | RHB + RHR | RHG | — | Red | RHB + LHR | Blue | LHG |
| W-RHCP | Green | RHB + RHR | RHG | — | Blue | RHR + LHB | Red | LHG |
| W-RHCP | — | RHB + RHR | LHG | Green | Red | RHB + LHR | Blue | LHG |
| W-RHCP | — | RHB + RHR | LHG | Green | Blue | RHR + LHB | Red | LHG |
| W-RHCP | Blue | RHG + RHR | RHB | — | Red | RHG + LHR | Green | LHB |
| W-RHCP | Blue | RHG + RHR | RHB | — | Green | RHR + LHG | Red | LHB |
| W-RHCP | — | RHG + RHR | LHB | Blue | Red | RHG + LHR | Green | LHB |
| W-RHCP | — | RHG + RHR | LHB | Blue | Green | RHR + LHG | Red | LHB |
| W-RHCP | Red | RHG + RHB | RHR | — | Blue | RHG + LHB | Green | LHR |
| W-RHCP | Red | RHG + RHB | RHR | — | Green | RHB + LHG | Blue | LHR |
| W-RHCP | — | RHG + RHB | LHR | Red | Blue | RHG + LHB | Green | LHR |
| W-RHCP | — | RHG + RHB | LHR | Red | Green | RHB + LHG | Blue | LHR |
| — | — | — | — | — | — | — | — | — |
| W-LHCP | Green | LHB + LHR | LHG | — | Red | LHB + RHR | Blue | RHG |
| W-LHCP | Green | LHB + LHR | LHG | — | Blue | LHR + RHB | Red | RHG |
| W-LHCP | — | LHB + LHR | RHG | Green | Red | LHB + RHR | Blue | RHG |
| W-LHCP | — | LHB + LHR | RHG | Green | Blue | LHR + RHB | Red | RHG |
| W-LHCP | Blue | LHG + LHR | LHB | — | Red | LHG + RHR | Green | RHB |
| W-LHCP | Blue | LHG + LHR | LHB | — | Green | LHR + RHG | Red | RHB |
| W-LHCP | — | LHG + LHR | RHB | Blue | Red | LHG + RHR | Green | RHE |
| W-LHCP | — | LHG + LHR | RHB | Blue | Green | LHR + RHG | Red | RHB |
| W-LHCP | Red | LHG + LHB | LHR | — | Blue | LHG + RHB | Green | RHR |
| W-LHCP | Red | LHG + LHB | LHR | — | Green | LHB + RHG | Blue | RHR |
| W-LHCP | — | LHG + LHB | RHR | Red | Blue | LHG + RHB | Green | RHR |
| W-LHCP | — | LHG + LHB | RHR | Red | Green | LHB + RHG | Blue | RHR |

Other prism designs may also be arranged to take advantage of the design principles elaborated upon in either Table 1 or Table 2. The polarization of the input light may be produced by an illuminator outputting left or right hand circularly polarized light, or other techniques (e.g., unpolarized light source in combination with a circular polarizer, such as a waveplate placed before the input of the prism assembly or beam splitters.

Certain advantages may occur based on the design and other factors associated with a device using the prism assembly. For example, an illuminator used in an HDTV projection television or other display may have a stronger presence in the red and green light bands as compared to the blue light bands. Further, glass and other optical components absorb varying amounts of light in different wavelengths, leading to non uniform amount of the primary colors of light traveling through the prism assembly. For example, glass components absorb more blue light than green. Thus, it may be advantageous to place the “blue” microdisplay on a beam splitter that does not further split the light directed to the blue microdisplay. Example configurations having this design feature include FIGS. 20 and 21 in each case where the blue microdisplay is located on one face of a particular beam splitter and the other face of the same beam splitter is vacant.

In describing the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing cholesteric composed of a layer of cholesteric film, any other equivalent device, such as a cholesteric liquid embedded between layers of glass, or another device having an equivalent function or capability, whether or not listed herein, may be substituted therewith. Furthermore, the inventors recognize that newly developed technologies not now known may also be substituted for the described parts and still not depart from the scope of the present invention. All other described items, including, but not limited to prisms, optical elements, depositions, films, encapsulated materials, fittings, air gaps, spacer elements, angles of incidence, re-arrangement or alternative placement of materials, etc should also be consider in light of any and all available equivalents.

The present invention may suitably comprise, consist of, or consist essentially of, any of part of the invention or inventions described herein. For example, any of CBSs, PBSs, dichroics, polarizers, microdisplays, liquid joints, pathlength matching in a prism assembly design, pathlength matching in a beam splitting device, single or dual layer thin films and/or cholesterics, and any device equivalent in either structure or function to those listed here or elsewhere in this application. Further, the present invention illustratively disclosed herein may be practiced in the absence of any element, whether or not specifically disclosed herein.

Obviously, numerous modifications and variations of the present invention are possible in light of the above teachings. It is therefore to be understood that within the scope of the appended claims, the invention may be practiced otherwise than as specifically described herein.

1. A beam splitter comprising a cholesteric layer.

2. The beam splitter according to claim 1, wherein the cholesteric layer is supported on a substrate.

3. The beam splitter according to claim 1, further comprising a prism having a diagonal, wherein the cholesteric layer is supported on the diagonal of the prism.

4. The beam splitter according to claim 1, further comprising a substrate of neutral optical properties, wherein the cholesteric layer is supported by the substrate.

5. The beam splitter according to claim 1, further comprising a first prism having a first diagonal and a second prism having a second diagonal, wherein the first prism and the second prism are abutted to each other along their diagonals, and the cholesteric layer is disposed between the diagonals.

6. A beam splitter, comprising: a first prism having a first diagonal;
a second prism having a second diagonal; and
a cholesteric layer disposed between the diagonals wherein the first prism and the second prism are abutted to each other along their diagonals at the cholesteric layer.

7. The beam splitter according to claim 6, wherein the prisms are set in beam splitter pathlength matched positions.

8. The beam splitter according to claim 6, wherein the cholesteric layer comprises a first color cholesteric layer and a second color cholesteric layer.

9. The beam splitter according to claim 8, wherein the first color cholesteric layer comprises a blue cholesteric layer and the second color cholesteric layer comprises a red cholesteric layer.

10. The beam splitter according to claim 8, wherein the first color cholesteric layer comprises a blue cholesteric layer and the second color cholesteric layer comprises a green cholesteric layer.

11. The beam splitter according to claim 8, wherein the first color cholesteric layer comprises a green cholesteric layer and the second color cholesteric layer comprises a red cholesteric layer.

12. The beam splitter according to claim 8, wherein the first color cholesteric layer comprises a blue cholesteric layer and the second color cholesteric layer comprises a red cholesteric layer.

13. The beam splitter according to claim 8, wherein the first color cholesteric layer comprises a blue cholesteric layer and the second color cholesteric layer comprises a green cholesteric layer.

14. The beam splitter according to claim 8, wherein the first color cholesteric layer comprises a green cholesteric layer and the second color cholesteric layer comprises a red cholesteric layer.

15. A prism assembly, comprising a set of optical components including at least one cholesteric based beam splitter.

16. The prism assembly according to claim 15, wherein the prism assembly is configured to split an input light beam into at least 3 independent light channels, using only cholesteric based beam splitters.

17. The prism assembly according to claim 15, wherein the cholesteric based beam splitter comprises a substrate and a cholesteric layer supported on the substrate.

18. The prism assembly according to claim 15, wherein the cholesteric based beam splitter comprises a prism having a diagonal and a cholesteric layer is supported on the diagonal of the prism.

19. The prism assembly according to claim 18, wherein the first color cholesteric layer comprises a blue cholesteric layer and the second color cholesteric layer comprises a red cholesteric layer.

20. The prism assembly according to claim 18, wherein the first color cholesteric layer comprises a blue cholesteric layer and the second color cholesteric layer comprises a green cholesteric layer.

21. The prism assembly according to claim 18, wherein the first color cholesteric layer comprises a green cholesteric layer and the second color cholesteric layer comprises a red cholesteric layer.

22. The prism assembly according to claim 15, wherein the prism assembly is part of a projection television.

23. The prism assembly according to claim 15, wherein the set of optical components are set in prism assembly pathlength matched positions.

24. The prism assembly according to claim 23, wherein the prism assembly is part of a Liquid Crystal on Silicon (LCOS) projection HDTV.

25. A prism assembly, comprising a set of beam splitters configured to split an incoming light beam into at least 3 different channels, wherein the beam splitters are constructed as pathlength matched beam splitters and the beam spliters are secured in prism assembly pathlength matched positions.

26. The prism assembly according to claim 25, wherein at least one of the beam splitters comprise a cholesteric based beam splitter.

27. The prism assembly according to claim 26, wherein the cholesteric based beam splitter is constructed as a pathlength matched beam splitter.

28. The prism assembly according to claim 26, wherein:
the cholesteric based beam splitter comprises a first prism having a first diagonal and a second prism having a second diagonal;
the first prism and the second prism are abutted to each other along their diagonals; and
the cholesteric based beam splitter further comprises a cholesteric layer is disposed between the diagonals.

29. The beam splitter according to claim 28, wherein the cholesteric layer comprises a blue cholesteric layer and a red cholesteric layer.

30. The beam splitter according to claim 28, wherein the cholesteric layer comprises a blue cholesteric layer and a green cholesteric layer.

31. The beam splitter according to claim 28, wherein the cholesteric layer comprises a green cholesteric layer and a red cholesteric layer.

32. The prism assembly according to claim 25, wherein at least one of the beam splitters is a polarizing beam splitter and at least one of the beam splitters is a cholesteric based beam splitter.

33. A quad style prism assembly, comprising:
an input beam splitter;
a first processing beam splitter comprising at least one processing face adaptable to a modulation device;
a second processing beam splitter comprising at least one processing face adaptable to a modulation device; and
an output re-combination beam splitter.
wherein at least one of the beam splitters comprise a cholesteric based beam splitter.

34. The quad style prism assembly according to claim 33, wherein:
the cholesteric based beam splitter comprises a first prism having a first diagonal and a second prism having a second diagonal;
the first prism and the second prism are abutted to each other along their diagonals; and
the cholesteric based beam splitter further comprises a cholesteric layer is disposed between the diagonals.

35. The quad style prism assembly according to claim 33, wherein:
the input beam splitter comprises a dichroic beam splitter;
the first processing beam splitter comprises a polarizing beam splitter;
the second processing beam splitter comprises a cholesteric based beam splitter; and
the output re-combination beam splitter comprises a polarizing beam splitter.

36. The quad style prism assembly according to claim 35, wherein:
the dichroic beam splitter comprises a Magenta dichroic beam splitting element.

37. The quad style prism assembly according to claim 35, wherein the cholesteric based beam splitter comprises a dual color cholesteric layer.

38. The quad style prism assembly according to claim 37, wherein the dual color cholesteric layer comprises a blue cholesteric layer having a first handedness, and a red cholesteric layer having a second handedness opposite the first handedness.

39. The quad style prism assembly according to claim 37, wherein the dual color cholesteric layer comprises a right hand blue cholesteric layer and a left hand red cholesteric layer.

40. The quad style prism assembly according to claim 33, wherein:
the input beam splitter comprises a polarizing beam splitter;
the first processing beam splitter comprises a polarizing beam splitter;
the second processing beam splitter comprises a cholesteric based beam splitter; and
the output re-combination beam splitter comprises a polarizing beam splitter.

41. The quad style prism assembly according to claim 40, wherein the dual color cholesteric layer comprises a blue cholesteric layer having a first handedness, and a red cholesteric layer having a second handedness opposite the first handedness.

42. The quad style prism assembly according to claim 40, wherein the dual color cholesteric layer comprises a blue cholesteric layer having a first handedness, and a green cholesteric layer having a second handedness opposite the first handedness.

43. The quad style prism assembly according to claim 41, wherein the dual color cholesteric layer comprises a green cholesteric layer having a first handedness, and a red cholesteric layer having a second handedness opposite the first handedness.

44. The quad style prism assembly according to claim 33, wherein adjacent beam splitters are liquid coupled.

45. The quad style prism assembly according to claim 33, further comprising a set of optical elements position between interspersed between adjacent beam splitters.

46. The quad style prism assembly according to claim 45, wherein adjacent beam splitters and optical elements between the adjacent beam splitters are liquid coupled.

47. The quad style prism assembly according to claim 45, wherein the beam splitters are set in prism assembly pathlength matched positions.

48. The quad style prism assembly according to claim 33, wherein at least one of the beam splitters is constructed as a pathlength matched beam splitter.

49. The quad style prism assembly according to claim 33, wherein all of the beam splitters are cholesteric based beam splitters.

50. The quad style prism assembly according to claim 33, wherein:
the input beam splitter comprises a first color cholesteric layer having a first hand direction;
the first processing beam splitter comprises a cholesteric layer of the first color and having the first hand direction;
the second processing beam splitter comprises a second color cholesteric layer having the first hand direction and a third color cholesteric layer having a second hand direction opposite the first hand direction; and
the output beam splitter comprises cholesteric layer of the first color having the first hand direction.

51. The quad style prism assembly according to claim 50, wherein the first color is green, the second color is blue, and the third color is red.

52. The quad style prism assembly according to claim 50, wherein the first color is green, the second color is red, and the third color is blue.

53. The quad style prism assembly according to claim 50, wherein the first color is blue, the second color is red, and the third color is green.

54. The quad style prism assembly according to claim 50, wherein the first color is blue, the second color is green, and the third color is red.

55. The quad style prism assembly according to claim 50, wherein the first color is red, the second color is blue, and the third color is green.

56. The quad style prism assembly according to claim 50, wherein the first color is red, the second color is green, and the third color is blue.

57. The quad style prism assembly according to claim 50, wherein the first hand direction is a right hand direction, and the second hand direction is a left hand direction.

58. The quad style prism assembly according to claim 50, wherein the first hand direction is a left hand direction, and the second hand direction is a right hand direction.

59. The quad style prism assembly according to claim 50, wherein each beam splitter comprises a substrate configured to support the beam splitter's cholesteric layer.

60. The quad style prism assembly according to claim 59, wherein the cholesteric layers are positioned in prism assembly pathlength matched positions.

61. The quad style prism assembly according to claim 50, wherein:
at least one of the beam splitters comprises a first prism having a first diagonal and a second prism having a second diagonal, the first diagonal adjacent to the second diagonal, and the cholesteric layer disposed between the diagonals.

62. The quad style prism assembly according to claim 50, wherein:
at least one of the beam splitters comprises a first prism having a first diagonal and a second prism having a second diagonal, the first diagonal adjacent to the second diagonal, and the cholesteric layer disposed between the diagonals; and
the cholesteric layer comprises a first color cholesteric layer disposed on the first prism diagonal, and a second color cholesteric layer disposed on the second prism diagonal.

63. The quad style prism assembly according to claim 62, wherein the first color cholesteric layer and the second color cholesteric layer have opposite handed directivities.

64. The quad style prism assembly according to claim 50, wherein the prism assembly is part of kernel in a Liquid Crystal on Silicon projection monitor.

65. The quad style prism assembly according to claim 64, wherein the projection monitor is an HDTV.

66. A Liquid Crystal on Silicon (LCOS) High Definition monitor, comprising:
a Light Management System (LMS), comprising an LCOS based kernel having a prism assembly comprising a set of optical components including at least one cholesteric based beam splitter.

67. The Liquid Crystal on Silicon (LCOS) High Definition monitor according to claim 66, further comprising any of a television receiver, DVD player, cable box, and other image source configured to provide image signals to the kernel.
